(19) United States
(12) Patent Application Publication
(10) Pub. No.: US 2013/0121417 A1
(43) Pub. Date: May 16, 2013

(54) CONSTRAINED REFERENCE PICTURE SETS IN WAVE FRONT PARALLEL PROCESSING OF VIDEO DATA

(71) Applicant: QUALCOMM INCORPORATED, San Diego, CA (US)

(72) Inventors: In Suk Chong, San Diego, CA (US); Muhammed Zeyd Coban, Carlsbad, CA (US); Marta Karczewicz, San Diego, CA (US)

(73) Assignee: QUALCOMM INCORPORATED, San Diego, CA (US)

(21) Appl. No.: 13/672,265

(22) Filed: Nov. 8, 2012

Related U.S. Application Data
(60) Provisional application No. 61/560,737, filed on Nov. 16, 2011.

(51) Int. Cl. H04N 7/26

(52) U.S. Cl. CPC H04N 19/00545
USPC 375/240.15

(57) ABSTRACT

A video encoder determines reference blocks for each inter-predicted prediction unit (PU) of a tree block group such that each of the reference blocks is in a reference picture that is in a reference picture subset for the tree block group. The reference picture subset for the tree block group includes less than all reference pictures in a reference picture set of the current picture. The tree block group comprises a plurality of concurrently-coded tree blocks in the current picture. For each inter-predicted PU of the tree block group, the video encoder indicates, in a bitstream that includes a coded representation of video data, a reference picture that includes the reference block for the inter-predicted PU. A video decoder receives the bitstream, determines the reference pictures of the inter-predicted PUs of the tree block group, and generates decoded video blocks using the reference blocks of the inter-predicted PUs.

This application claims the benefit of U.S. Provisional Patent Application No. 61/560,737, filed Nov. 16, 2011, the entire content of which is hereby incorporated by reference.

### TECHNICAL FIELD

This disclosure relates to video coding (i.e., encoding and/or decoding of video data).

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video compression techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard presently under development, and extensions of such standards. The video devices may transmit, receive, encode, decode, and/or store digital video information more efficiently by implementing such video compression techniques.

Video compression techniques perform spatial (intra-picture) prediction and/or temporal (inter-picture) prediction to reduce or remove redundancy inherent in video sequences. For block-based video coding, a video slice (i.e., a video frame or a portion of a video frame) may be partitioned into video blocks, which may also be referred to as tree blocks, coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to a reference frames.

Spatial or temporal prediction results in a predictive block for a block to be coded. Residual data represents pixel differences between the original block to be coded and the predictive block. An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the pixel domain to a transform domain, resulting in residual coefficients, which then may be quantized. The quantized coefficients, initially arranged in a two-dimensional array, may be scanned in order to produce a one-dimensional vector of coefficients, and entropy coding may be applied to achieve even more compression.

### SUMMARY

In general, a video encoder determines one or more reference blocks for inter-predicted prediction units (PUs) of a tree block group of a current picture. The tree block group comprises a plurality of concurrently-coded tree blocks in the current picture. The video encoder determines the reference blocks such that each of the reference blocks is in a reference picture that is in a reference picture subset for the tree block group. The reference picture subset for the tree block group includes less than all reference pictures in a reference picture set of the current picture. For each inter-predicted PU of the tree block group, the video encoder indicates, in a bitstream, a reference picture that includes the reference block for the inter-predicted PU. A video decoder receives the bitstream, determines the reference pictures of the inter-predicted PUs of the tree block group, and generates decoded video blocks using the reference blocks of the inter-predicted PUs.

In one aspect, this disclosure describes a method for encoding video data. The method comprises determining a reference picture set comprising a plurality of reference pictures for a current picture. The method also comprises determining reference blocks for each inter-predicted PU of a tree block group of the current picture such that each of the reference blocks is in a reference picture that is in a reference picture subset for the tree block group, the reference picture subset for the tree block group including one or more, but less than all, of the reference pictures in the reference picture set for the current picture, the tree block group comprising a plurality of concurrently-coded tree blocks in the current picture. The method also comprises indicating, in a bitstream that includes a coded representation of the video data, reference pictures that include the reference blocks for each inter-predicted PU of the tree block group.

In another aspect, this disclosure describes a computing device that comprises one or more processors configured to determine a reference picture set comprising a plurality of reference pictures for a current picture. The one or more processors are also configured to determine reference blocks for each inter-predicted PU of a tree block group of the current picture such that each of the reference blocks is in a reference picture that is in a reference picture subset for the tree block group, the reference picture subset for the tree block group including one or more, but less than all, of the reference pictures in the reference picture set for the current picture, the tree block group comprising a plurality of concurrently-coded tree blocks in the current picture. In addition, the one or more processors are configured to indicate, in a bitstream that includes a coded representation of the video data, reference pictures that include the reference blocks for each inter-predicted PU of the tree block group.

In another aspect, this disclosure describes a computing device that comprises means for determining a reference picture set comprising a plurality of reference pictures for a current picture. The computing device also comprises means for determining reference blocks for each inter-predicted PU of a tree block group of the current picture such that each of the reference blocks is in a reference picture that is in a reference picture subset for the tree block group, the reference picture subset for the tree block group including one or more, but less than all, of the reference pictures in the reference picture set for the current picture, the tree block group comprising a plurality of concurrently-coded tree blocks in the current picture. In addition, the computing device comprises means for indicating, in a bitstream that includes a coded representation of video data, reference pictures that include the reference blocks for each inter-predicted PU of the tree block group.

In another aspect, this disclosure describes a computer-readable storage medium that stores instructions that, when executed by one or more processors of a computing device, cause the computing device to determine a reference picture set comprising a plurality of reference pictures for a current picture. The instructions also cause the computing device to determine reference blocks for each inter-predicted PU of a tree block group of the current picture such that each of the reference blocks is in a reference picture that is in a reference picture subset for the tree block group, the reference picture subset for the tree block group including one or more, but less than all, of the reference pictures in the reference picture set of the current picture, the tree block group comprising a plurality of concurrently-coded tree blocks in the current picture. In addition, the instructions cause the computing device to indicate, in a bitstream that includes a coded representation of video data, reference pictures that include the reference blocks for each inter-predicted PU of the tree block group.

In another aspect, this disclosure describes a method for decoding video data. The method comprises receiving a bitstream that includes an encoded representation of the video data, the encoded representation of the video data including data that signal motion information of inter-predicted PUs of a tree block group of a current picture of the video data. The tree block group comprises a plurality of concurrently-coded tree blocks in the current picture. The tree block group is associated with a reference picture subset that includes one or more, but less than all, reference pictures in a reference picture set for the current picture. The method also comprises determining, based on the motion information of the inter-predicted PUs of the tree block group, reference blocks of the inter-predicted PUs. Each of the reference blocks of the inter-predicted PUs of the tree block group is within a reference picture in a reference picture subset defined for the tree block group. In addition, the method comprises generating, based at least in part on the reference blocks of the inter-predicted PUs of the tree block group, decoded video blocks of the current picture.

In another aspect, this disclosure describes a computing device that comprises one or more processors configured to receive a bitstream that includes an encoded representation of video data, the encoded representation of the video data including data that signal motion information of inter-predicted PUs of a tree block group of a current picture of the video data. The tree block group comprises a plurality of concurrently-coded tree blocks in the current picture. The tree block group is associated with a reference picture subset that includes one or more, but less than all, reference pictures in a reference picture set for the current picture. The one or more processors are also configured to determine, based on the motion information of the inter-predicted PUs of the tree block group, reference blocks of the inter-predicted PUs. Each of the reference blocks of the inter-predicted PUs of the tree block group is within a reference picture in a reference picture subset defined for the tree block group. In addition, the one or more processors are configured to generate, based at least in part on the reference blocks of the inter-predicted PUs of the tree block group, decoded video blocks of the current picture.

In another aspect, this disclosure describes a computing device that comprises means for receiving a bitstream that includes an encoded representation of video data, the encoded representation of the video data including data that signal motion information of inter-predicted PUs of a tree block group of a current picture of the video data. The tree block group comprises a plurality of concurrently-coded tree blocks in the current picture. The tree block group is associated with a reference picture subset that includes one or more, but less than all, reference pictures in a reference picture set for the current picture. The computing device also comprises means for determining, based on the motion information of the inter-predicted PUs of the tree block group, reference blocks of the inter-predicted PUs. Each of the reference blocks of the inter-predicted PUs of the tree block group is within a reference picture in a reference picture subset defined for the tree block group. In addition, the computing device comprises means for generating, based at least in part on the reference blocks of the inter-predicted PUs of the tree block group, decoded video blocks of the current picture.

In another aspect, this disclosure describes a computer-readable storage medium that stores instructions that, when executed by one or more processors of a computing device, cause the computing device to receive a bitstream that includes an encoded representation of video data, the encoded representation of the video data including data that signal motion information of inter-predicted PUs of a tree block group of a current picture of the video data. The tree block group comprises a plurality of concurrently-coded tree blocks in the current picture. The tree block group is associated with a reference picture subset that includes one or more, but less than all, reference pictures in a reference picture set for the current picture. The instructions also cause the computing device to determine, based on the motion information of the inter-predicted PUs of the tree block group, reference blocks of the inter-predicted PUs. Each of the reference blocks of the inter-predicted PUs of the tree block group is within a reference picture in a reference picture subset defined for the tree block group. In addition, the instructions cause the computing device to generate, based at least in part on the reference blocks of the inter-predicted PUs of the tree block group, decoded video blocks of the current picture.

The details of one or more examples of the disclosure are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example video encoding and decoding system that may utilize the techniques described in this disclosure.

FIG. 2 is a conceptual diagram illustrating wavefront parallel processing.

FIG. 3 is a block diagram illustrating an example video encoder that is configured to implement the techniques of this disclosure.

FIG. 4 is a block diagram illustrating an example video decoder that is configured to implement the techniques of this disclosure.

FIG. 5 is a flowchart that illustrates an example operation of the video encoder to encode video data using constrained reference picture sets, in accordance with one or more techniques of this disclosure.

FIG. 6 is a flowchart that illustrates an example operation of the video encoder to process a tree block group, in accordance with one or more techniques of this disclosure.

FIG. 7 is a flowchart that illustrates an example operation of the video decoder to process a current tree block group, in accordance with one or more techniques of this disclosure.

FIG. 8 is a conceptual diagram that illustrates an example approach for constraining the reference picture set of a picture, in accordance with one or more techniques of this disclosure.

FIG. 9 is a conceptual diagram that illustrates another example approach for constraining the reference picture set of a picture, in accordance with one or more techniques of this disclosure.

FIG. 10 is a conceptual diagram that illustrates another example approach for constraining the reference picture set of a picture, in accordance with one or more techniques of this disclosure.

### DETAILED DESCRIPTION

A video coder (i.e., a video encoder or a video decoder) may associate a picture with a set of reference pictures (i.e., a reference picture set (RPS)). The video coder may store one or more of the reference pictures associated with the picture in a reference picture buffer. The video coder may perform wavefront parallel processing (WPP) to code (i.e., encode or decode) a picture. When coding the picture using WPP, the video coder may concurrently code multiple tree blocks of the picture. For ease of explanation, this disclosure may refer to a group of concurrently-coded tree blocks as a “tree block group.” When concurrently coding multiple tree blocks of the picture, the video coder may concurrently perform inter prediction on multiple prediction units (PUs) of the tree blocks. As part of performing inter prediction on a PU, the video coder may use samples from one or more of the reference pictures associated with the picture to generate predictive sample blocks that correspond to the PU.

If the video coder codes multiple tree blocks concurrently, as may occur when the video coder performs WPP, the reference picture buffer may be too small to store the reference pictures used for performing inter prediction on PUs of each of the concurrently-coded tree blocks. As a result, the reference picture buffer is less likely to store the reference picture that the video coder needs at any given time. If the reference picture buffer does not store a needed reference picture, the video coder may retrieve that needed reference picture from a secondary storage medium. Retrieving the needed reference picture from the secondary storage medium may be relatively time-consuming. Thus, if the reference picture buffer does not store the reference pictures needed to perform inter prediction on PUs of the concurrently-coded tree blocks (i.e., the PUs of the tree blocks of a tree block group), performance of the video coder may be diminished.

In accordance with the techniques of this disclosure, a video encoder may associate each tree block in a tree block group with the same constrained subset of the reference pictures associated with a current picture. Hence, each tree block in a tree block shares the same subset of reference pictures, such that inter prediction is performed with respect to that subset of reference pictures. The shared subset of reference pictures may include a reduced number of reference pictures and present a reduced storage requirement for the reference picture buffer. Consequently, the reference picture buffer may be able to concurrently store each reference picture in the constrained subset of the reference pictures. This may ensure that a required set of reference pictures is available in the reference picture buffers of both the video encoder and video decoder when needed during encoding and decoding operations. This may accelerate the operation of the video encoder and/or the video decoder.

The attached drawings illustrate examples. Elements indicated by reference numbers in the attached drawings correspond to elements indicated by like reference numbers in the following description. In this disclosure, elements having names that start with ordinal words (e.g., “first,” “second,” “third,” and so on) do not necessarily imply that the elements have a particular order. Rather, such ordinal words are merely used to refer to different elements of a same or similar type.

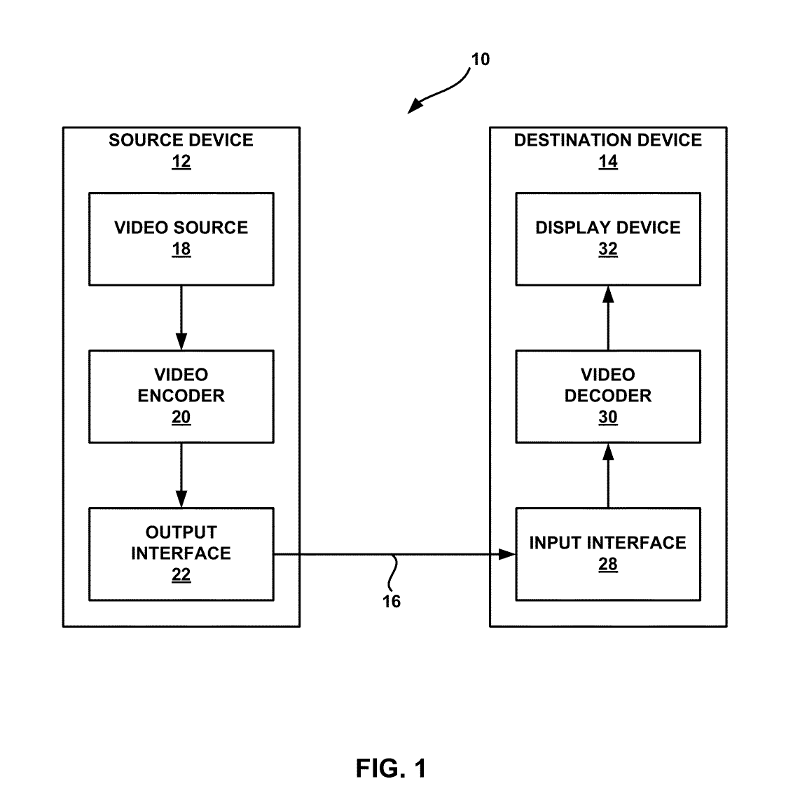

FIG. 1 is a block diagram that illustrates an example video encoding and decoding system 10 that may utilize the techniques of this disclosure. As used described herein, the term “video coder” refers generically to both video encoders and video decoders. In this disclosure, the terms “video coding” or “coding” may refer generically to video encoding or video decoding.

As shown in FIG. 1, video encoding and decoding system 10 includes a source device 12 and a destination device 14. Source device 12 generates encoded video data. Accordingly, source device 12 may be referred to as a video encoding device or a video encoding apparatus. Destination device 14 may decode the encoded video data generated by source device 12. Accordingly, destination device 14 may be referred to as a video decoding device or a video decoding apparatus. Source device 12 and destination device 14 may be examples of video coding devices or video coding apparatuses.

Source device 12 and destination device 14 may comprise a wide range of devices, including desktop computers, mobile computing devices, notebook (e.g., laptop) computers, tablet computers, set-top boxes, telephone handsets such as so-called “smart” phones, televisions, cameras, display devices, digital media players, video gaming consoles, in-car computers, or the like.

Destination device 14 may receive encoded video data from source device 12 via a channel 16. Channel 16 may comprise a type of medium or device capable of moving the encoded video data from source device 12 to destination device 14. In one example, channel 16 may comprise one or more communication media that enable source device 12 to transmit encoded video data directly to destination device 14 in real-time. In this example, source device 12 may modulate the encoded video data according to a communication standard, such as a wireless communication protocol, and may transmit the modulated video data to destination device 14. The one or more communication media may include wireless and/or wired communication media, such as a radio frequency (RF) spectrum or one or more physical transmission lines. The one or more communication media may form part of a packet-based network, such as a local area network, a wide-area network, or a global network (e.g., the Internet). The one or more communication media may include routers, switches, base stations, or other equipment that facilitate communication from source device 12 to destination device 14.

In another example, channel 16 may include a storage medium that stores encoded video data generated by source device 12. In this example, destination device 14 may access the storage medium via disk access or card access. The storage medium may include a variety of locally-accessed data storage media such as Blu-ray discs, DVDs, CD-ROMs, flash memory, or other suitable storage media for storing encoded video data.

In a further example, channel 16 may include a device, such as a file server or another intermediate storage device, that stores encoded video data generated by source device 12. In this example, destination device 14 may access encoded video data stored at the device via streaming or download. A file server may be a computing device configured to store encoded video data and to transmit the encoded video data to another computing device, such as destination device 14. Example types of file servers include web servers (e.g., for a website), file transfer protocol (FTP) servers, network attached storage (NAS) devices, and local disk drives.

Destination device 14 may access the encoded video data through a standard data connection, such as an Internet connection. Example types of data connections may include wireless channels (e.g., Wi-Fi connections), wired connections (e.g., DSL, cable modem, etc.), or combinations of both that are suitable for transmission of encoded video data. The transmission of the encoded video data may be a streaming transmission, a download transmission, or a combination of both.

The techniques of this disclosure are not limited to wireless applications or settings. Rather, the techniques may be applied to video coding in support of a variety of multimedia applications, such as over-the-air television broadcasts, cable television transmissions, satellite television transmissions, streaming video transmissions, e.g., via the Internet, encoding of video data for storage on a data storage medium, decoding of video data stored on a data storage medium, or other applications. In some examples, video encoding and decoding system 10 may be configured to support one-way or two-way video transmission to support applications such as video streaming, video playback, video broadcasting, and/or video telephony.

In the example of FIG. 1, source device 12 includes a video source 18, a video encoder 20, and an output interface 22. Video source 18 may include a video capture device, e.g., a video camera, a video archive containing previously captured video data, a video feed interface to receive video data from a video content provider, and/or a computer graphics system for generating video data, or a combination of such sources of video data.

Video encoder 20 may encode video data from video source 18. In some examples, source device 12 may directly transmit the encoded video data to destination device 14 via output interface 22. In some examples, output interface 22 may include a modulator/demodulator (modem) and/or a transmitter. The encoded video data may also be stored onto a storage medium or a file server for later access by destination device 14 for decoding and/or playback.

In the example of FIG. 1, destination device 14 includes an input interface 28, a video decoder 30, and a display device 32. Input interface 28 may receive encoded video data over channel 16. In some examples, input interface 28 may include a receiver and/or a modem. Video decoder 30 may decode encoded video data. Display device 32 may display video data decoded by video decoder 30.

Display device 32 may be integrated with or may be external to destination device 14. Display device 32 may comprise a variety of display devices, such as a liquid crystal display (LCD), a plasma display, an organic light emitting diode (OLED) display, or another type of display device.

Video encoder 20 and video decoder 30 may operate according to a video compression standard, such as the High Efficiency Video Coding (HEVC) standard presently under development, and may conform to a HEVC Test Model (HM). A recent draft of the upcoming HEVC standard, referred to as “HEVC Working Draft 4” or “WD4,” is described in Bross et al., “WD4: Working Draft 4 of High-Efficiency Video Coding,” Joint Collaborative Team on Video Coding (JCT-VC) of ITU-T SG16 WP3 and ISO/IEC JTC1/SC29/WG11, 6th Meeting: Torino, Italy, July, 2011, which, as of Oct. 22, 2012, is downloadable from: http://phenix.int-evry.fr/jct/doc_end_user/documents/6_Torino/wg11/JCTVC-F803-v3.zip, the entire content of which is incorporated herein by reference. Another recent draft of the upcoming HEVC standard, referred to as “HEVC Working Draft 8” or “WD8,” is described in Bross et al., “High Efficiency Video Coding (HEVC) text specification draft 8,” Joint Collaborative Team on Video Coding (JCT-VC) of ITU-T SG16 WP3 and ISO/IEC JTC1/SC29/WG11, 10th Meeting: Stockholm, Sweden, July, 2012, which, as of Oct. 22, 2012, is downloadable from: http://phenix.it-sudparis.eu/jct/doc_end_user/documents/10_Stockholm/wg11/JCTVC-J1003-v8.zip, the entire content of which is incorporated herein by reference.

Alternatively, video encoder 20 and video decoder 30 may operate according to other proprietary or industry standards, including ITU-T H.261, ISO/IEC MPEG-1 Visual, ITU-T H.262 or ISO/IEC MPEG-2 Visual, ITU-T H.263, ISO/IEC MPEG-4 Visual, and ITU-T H.264 (also known as ISO/IEC MPEG-4 AVC or H.264/AVC), including its Scalable Video Coding (SVC) and Multiview Video Coding (MVC) extensions. However, the techniques of this disclosure are not limited to any particular coding standard or technique.

Again, FIG. 1 is merely an example and the techniques of this disclosure may apply to video coding settings (e.g., video encoding or video decoding) that do not necessarily include any data communication between the encoding and decoding devices. In other examples, data can be retrieved from a local memory, streamed over a network, or the like. An encoding device may encode and store data to memory, and/or a decoding device may retrieve and decode data from memory. In many examples, the encoding and decoding is performed by devices that do not communicate with one another, but simply encode data to memory and/or retrieve and decode data from memory.

Video encoder 20 and video decoder 30 each may be implemented as any of a variety of suitable circuitry, such as one or more microprocessors, digital signal processors (DSPs), application-specific integrated circuits (ASICs), field-programmable gate arrays (FPGAs), discrete logic, hardware, or any combinations thereof. In examples where the techniques are implemented partially in software, a device may store instructions for the software in a suitable, non-transitory computer-readable storage medium and may execute the instructions in hardware using one or more processors to perform the techniques of this disclosure. Any of the foregoing (including hardware, software, a combination of hardware and software, etc.) may be considered to be one or more processors. Each of video encoder 20 and video decoder 30 may be included in one or more encoders or decoders, either of which may be integrated as part of a combined encoder/decoder (CODEC) in a respective device.

This disclosure may generally refer to video encoder 20 “signaling” certain information to another device, such as video decoder 30. It should be understood, however, that video encoder 20 may signal information by associating certain syntax elements with various encoded portions of video data. That is, video encoder 20 may “signal” data by storing certain syntax elements to various encoded portions of video data. In some cases, such syntax elements may be encoded and stored (e.g., in a storage system) prior to being received and decoded by video decoder 30. Thus, the term “signaling” may generally refer to the communication of syntax elements and/or other data used to decode the encoded video data. Such communication may occur in real- or near-real-time. Alternately, such communication may occur over a span of time, such as might occur when storing syntax elements to a computer-readable storage medium in an encoded bitstream at the time of encoding, which then may be retrieved by a decoding device at any time after being stored to this medium.

As mentioned briefly above, video encoder 20 encodes video data. The video data may include a series of one or more pictures. Each of the pictures may be a still image forming part of a video. In some instances, a picture may be referred to as a video “frame.” Video encoder 20 may generate a bitstream that includes a sequence of bits that form a coded representation of the video data.

To generate the bitstream, video encoder 20 may generate a series of coded pictures and associated data. The coded pictures may be encoded representations of pictures in the video data. The associated data may include sequence parameter sets (SPSs), picture parameter sets (PPSs), and other syntax structures. A SPS may contain parameters applicable to zero or more sequences of pictures. A PPS may contain parameters applicable to zero or more pictures.

To generate an encoded representation of a picture, video encoder 20 may partition the picture into a plurality of tree blocks. In some instances, a tree block may be referred to as a largest coding unit (LCU), a “coding tree block,” or a “treeblock.” The tree blocks of HEVC may be broadly analogous to the macroblocks of previous standards, such as H.264/AVC. However, a tree block is not necessarily limited to a particular size and may include one or more coding units (CUs).

Each of the tree blocks may be associated with a different equally-sized block of pixels within the picture. Each pixel may comprise a luminance (luma) sample and two chrominance (chroma) samples. Thus, each tree block may be associated with a block luma samples and two blocks of chroma samples. For ease of explanation, this disclosure may refer to a two-dimensional array of pixels as a pixel block and may refer to a two-dimensional array of samples as a sample block. Video encoder 20 may use quad-tree partitioning to partition the pixel blocks associated with a tree block into pixel blocks associated with CUs, hence the name “tree blocks.”

In addition, video encoder 20 may partition a picture into a plurality of slices. Each of the slices may include an integer number of tree blocks. As part of encoding a picture, video encoder 20 may generate encoded representations of each slice of the picture (i.e., coded slices). To generate a coded slice, video encoder 20 may encode each tree block of the slice to generate encoded representations of each of the tree blocks of the slice (i.e., coded tree blocks).

To generate a coded tree block, video encoder 20 may recursively perform quad-tree partitioning on the pixel block associated with a tree block to divide the pixel block into progressively-smaller pixel blocks. Each of the smaller pixel blocks may be associated with a CU. A partitioned CU may be a CU whose pixel block is partitioned into pixel blocks associated with other CUs. A non-partitioned CU may be a CU whose pixel block is not partitioned into pixel blocks associated with other CUs.

Video encoder 20 may generate one or more prediction units (PUs) for each non-partitioned CU. Each of the PUs of a CU may be associated with a different pixel block within the pixel block of the CU. Video encoder 20 may generate predictive pixel blocks for each PU of the CU. The predictive pixel blocks of a PU may be blocks of pixels. In this disclosure, a PU may be said to be a PU of a tree block if the PU is of a CU of the tree block.

Video encoder 20 may use intra prediction or inter prediction to generate the predictive pixel block for a PU. If video encoder 20 uses intra prediction to generate the predictive pixel block of a PU, video encoder 20 may generate the predictive pixel block of the PU based on decoded pixels of the picture associated with the PU. If video encoder 20 uses inter prediction to generate the predictive pixel block of the PU, video encoder 20 may generate the predictive pixel block of the PU based on decoded pixels of one or more pictures other than the picture associated with the PU.

Video encoder 20 may generate a residual pixel block for a CU based on predictive pixel blocks of the PUs of the CU. The residual pixel block for the CU may indicate differences between samples in the predictive pixel blocks for the PUs of the CU and corresponding samples in the original pixel blocks of the CU.

Furthermore, as part of encoding a non-partitioned CU, video encoder 20 may perform recursive quad-tree partitioning on the residual pixel block of the CU to partition the residual pixel block of the CU into one or more smaller residual pixel blocks associated with transform units (TUs) of the CU. In this way, each TU of the CU may be associated with a residual sample block of luma samples and two residual sample blocks of chroma samples.

Video coder 20 may apply one or more transforms to residual sample blocks associated with the TUs to generate coefficient blocks (i.e., blocks of coefficients) associated with the TUs. Conceptually, a coefficient block may be a two-dimensional matrix of coefficients. Video encoder 20 may quantize the coefficient blocks. Quantization generally refers to a process in which coefficients are quantized to possibly reduce the amount of data used to represent the coefficients, providing further compression.

Video encoder 20 may generate sets of syntax elements that represent quantized coefficient blocks. Video encoder 20 may apply entropy encoding operations, such as Context Adaptive Binary Arithmetic Coding (CABAC) operations, to at least some of these syntax elements. As part of performing an entropy encoding operation, video encoder 20 may select a coding context. In the case of CABAC, the coding context may indicate probabilities of 0-valued and 1-valued bins. Video encoder 20 may use the coding context to encode one or more syntax elements.

The bitstream generated by video encoder 20 may include a series of Network Abstraction Layer (NAL) units. Each of the NAL units may be a syntax structure containing an indication of a type of data in the NAL unit and bytes containing the data. For example, a NAL unit may contain data representing a SPS, a PPS, a coded slice, supplemental enhancement information (SEI), an access unit delimiter, filler data, or another type of data. Coded slice NAL units are NAL units that include coded slices.

Video decoder 30 may receive a bitstream generated by video encoder 20. The bitstream may include a coded representation of video data encoded by video encoder 20. Video decoder 30 may parse the bitstream to extract syntax elements from the bitstream. As part of extracting syntax elements from the bitstream, video decoder 30 may perform entropy decoding (e.g., CABAC decoding) operations on data in the bitstream. Video decoder 30 may reconstruct the pictures of the video data based on the syntax elements extracted from the bitstream. The process to reconstruct the video data based on the syntax elements may be generally reciprocal to the process performed by video encoder 20 to generate the syntax elements.

Video decoder 30 may generate, based on syntax elements associated with a CU, predictive pixel blocks for PUs of the CU. In addition, video decoder 30 may inverse quantize coefficient blocks associated with TUs of the CU. Video decoder 30 may apply inverse transforms on the coefficient blocks to reconstruct residual sample blocks associated with the TUs of the CU. Video decoder 30 may reconstruct the pixel block of a CU based on the predictive sample blocks and the residual sample blocks.

If video decoder 30 uses inter prediction to generate the predictive sample blocks of a PU, video decoder 30 may use motion information for the PU to identify one or more reference blocks in a set of reference pictures associated a picture associated with the PU. Video decoder 30 may generate the predictive sample blocks of the PU based on the one or more reference blocks. Video decoder 30 may store in a reference picture buffer at least some of the reference pictures associated with a picture. In some examples, the reference picture buffer may be a buffer in a general memory of destination device 14. In other examples, the reference picture buffer may be a special-purpose memory dedicated to storing reference pictures.

Video encoder 20 and video decoder 30 may use wavefront parallel processing (WPP) to encode and decode pictures, respectively. To code a picture using WPP, a video coder, such as video encoder 20 and video decoder 30, may divide the tree blocks of the picture into a plurality of WPP waves. Each of the WPP waves may correspond to a different row of tree blocks in the picture. The video coder may start coding a top row of tree blocks, e.g., using a first coder core or thread. After the video coder has coded two or more tree blocks of the top row, the video coder may start coding a second-to-top row of tree blocks in parallel with coding the top row of tree blocks, e.g., using a second, parallel coder core or thread. After the video coder has coded two or more tree blocks of the second-to-top row, the video coder may start coding a third-to-top row of tree blocks in parallel with coding the higher rows of tree blocks, e.g., using a third, parallel coder core or thread. This pattern may continue down the rows of tree blocks in the picture.

When a video coder uses WPP to code a picture, this disclosure may refer to a set of tree blocks that the video coder is concurrently coding as a tree block group. Thus, when the video coder is using WPP to code a picture, each of the tree blocks of the tree block group is in a different row of tree blocks of the picture and each of the tree blocks of the tree block group is vertically offset from each other by two tree block columns of the picture.

Furthermore, when coding the picture using WPP, the video coder may use information associated with spatially-neighboring CUs outside a particular tree block to perform intra or inter prediction on a particular CU in the particular tree block, so long as the spatially-neighboring CUs are left, above-left, above, or above-right of the particular tree block. If the particular tree block is the leftmost tree block in a row other than the topmost row, the video coder may use information associated with the second tree block of the immediately higher row to select a coding context for entropy coding a syntax element of the particular tree block. Otherwise, if the particular tree block is not the leftmost tree block in the row, the video coder may use information associated with a tree block to the left of the particular tree block to select a coding context for entropy encoding a syntax element of the particular tree block. In this way, the video coder may initialize entropy coding (e.g., CABAC) states of a row of tree blocks based on the entropy coding states of the immediately higher row after encoding two or more tree blocks of the immediately higher row.

If the video coder codes multiple tree blocks concurrently, as may occur when the video coder performs WPP, the reference picture buffer of the video coder may not be large enough to store all of the reference pictures used for performing inter prediction on PUs of each of the concurrently-coded tree blocks (i.e., the tree blocks of a tree block group). If the video coder needs to use a reference picture that is not in the reference picture buffer, the video coder may retrieve the needed reference picture from a secondary storage location, such as a general system memory, or a hard disk, Flash or other longer-term storage drive of the video coder. In some examples, the reference picture buffer may be provided in a cache memory that is stored on-chip with the video coder and accessible via cache bus, whereas the secondary storage location may be off-chip relative to the video decoder, or in a system on a chip (SoC) design, on-chip but accessible via a system bus.

Retrieving the needed reference picture from the secondary storage location may be significantly slower than retrieving the needed reference picture from the reference picture buffer. Moreover, when the video coder retrieves a reference picture from the secondary storage location, the video coder may store the reference picture in the reference picture buffer, thereby overwriting another reference picture that is currently in the reference picture buffer. If the video coder subsequently needs the reference picture that was overwritten, the video coder may incur the delays associated with retrieving this other reference picture from the secondary storage location. Consequently, performance of the video coder may be diminished if the reference picture buffer does not store the reference pictures used for performing inter prediction on the PUs of the concurrently-coded tree blocks.

In accordance with the techniques of this disclosure, video encoder 20 may associate each set of concurrently-coded tree blocks (i.e., each tree block group) with a constrained subset of the reference pictures associated with a picture. The constrained subset of the reference pictures may include fewer than all of the reference pictures associated with the picture. This may ensure that the reference picture buffer stores each of reference pictures required to perform inter prediction on PUs of the tree blocks of the tree block group. Video encoder 20 may only use reference pictures in the constrained subset of the reference pictures associated with a tree block group to perform inter prediction on PUs of tree blocks of the tree block group. For ease of explanation, this disclosure may refer to a PU as an inter-predicted PU if the PU is encoded in a bitstream using inter prediction.

Thus, video encoder 20 may determine a reference picture set of a current picture. In addition, video encoder 20 may determine reference blocks for each inter-predicted PU of a tree block group such that each of the reference blocks is in a reference picture that is in a reference picture subset for the tree block group. The reference picture subset for the tree block group may include less than all reference pictures in the reference picture set of the current picture. The tree block group may comprise a plurality of concurrently-coded tree blocks in the current picture. Furthermore, video encoder 20 may indicate, in a bitstream that includes a coded representation of video data, reference pictures that include the reference blocks for each inter-predicted PU of the tree block group.

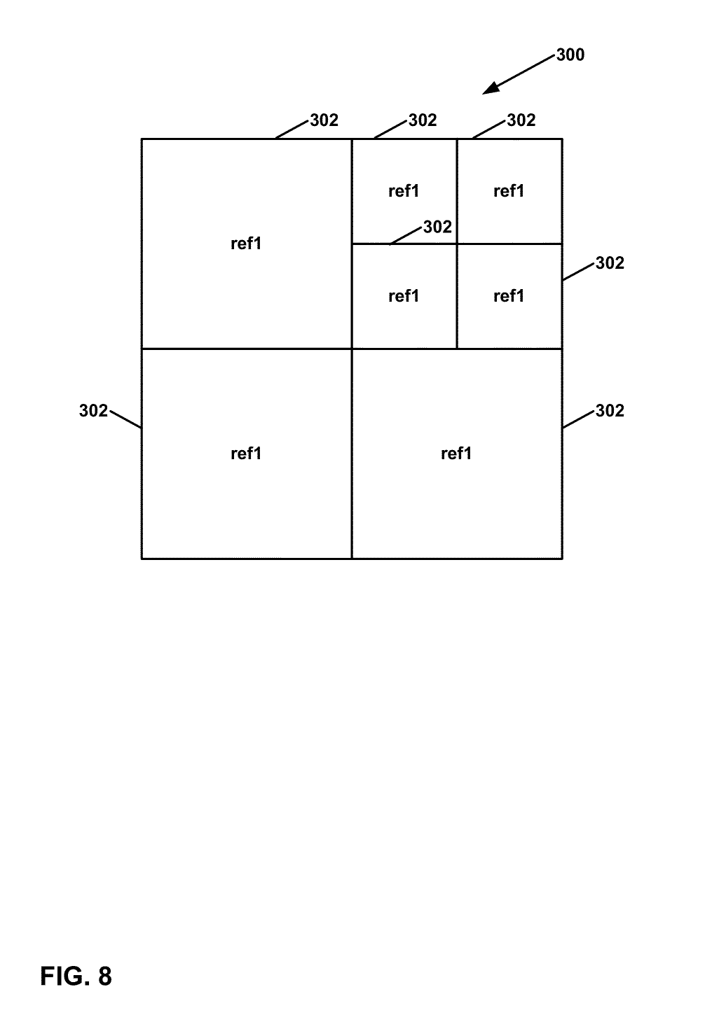

Video encoder 20 may determine a constrained reference picture subset of a tree block group in various ways. For example, video encoder 20 may determine a constrained reference picture subset of a tree block group based on a temporal range restriction. For instance, in this example, the constrained reference picture subset may be constrained to those reference pictures which are temporally no more than one or two pictures away from the current picture (i.e., the picture that video encoder 20 is currently encoding). Hence, to be included in the constrained reference picture set, in this example, a picture may be with two pictures prior to the current picture P0 or two pictures after the current picture. In other examples, the pictures in the constrained reference picture set could be no more than N pictures away from the current picture, where N may be greater than or less than 2. FIGS. 8-10, described below, are conceptual diagrams that illustrate example ways in which the reference picture set of a picture may be constrained for a tree block group.

Video encoder 20 may signal, in the bitstream, indexes of reference picture that include reference blocks of inter-predicted PUs. The index of a reference picture may be a unary number that indicates a position of the reference picture within a reference picture list. The reference pictures in the reference picture subset may be at earlier positions within the reference picture list. Hence, the number of bits required to signal the index of a reference picture in the constrained set of reference pictures may be smaller than the number of bits required to signal the index of the corresponding reference picture in the set of reference pictures associated with the current picture.

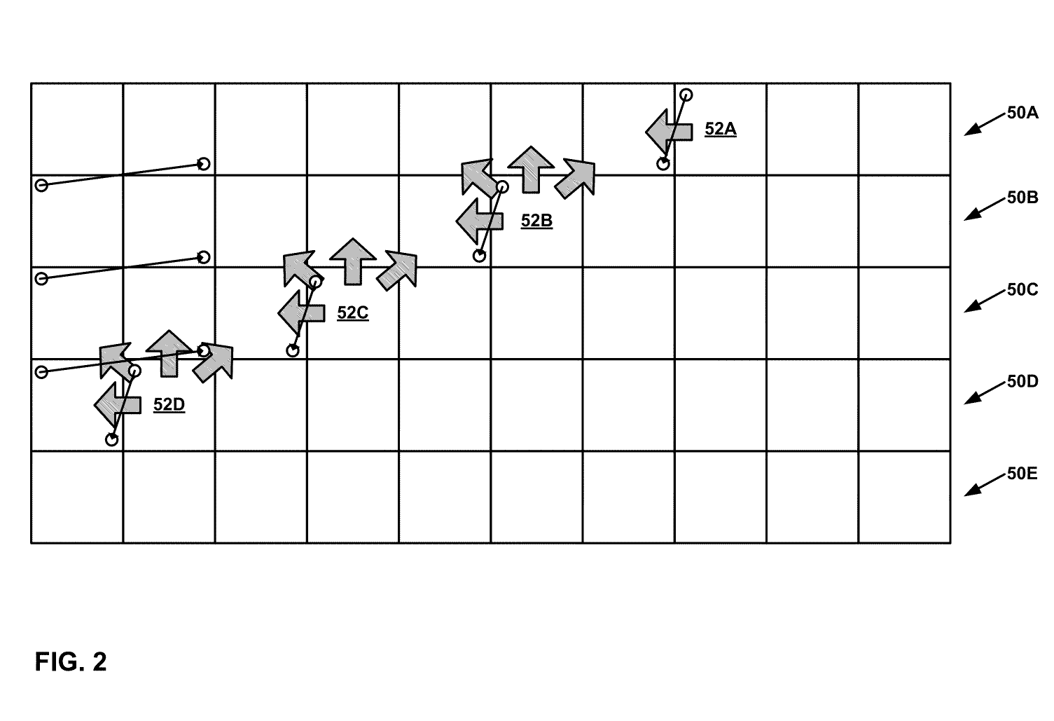

FIG. 2 is a conceptual diagram illustrating wavefront parallel processing. As described above, a picture may be partitioned into pixel blocks, each of which is associated with a tree block. FIG. 2 illustrates the pixel blocks associated with the tree blocks as a grid of white squares. The picture includes tree block rows 50A-50E (collectively, “tree block rows 50”).

A first thread, executed as a parallel thread with other threads on a single coder cores or executed on one of two or more parallel coder cores, may code tree blocks in tree block row 50A. Concurrently, other threads may code tree blocks in tree block rows 50B, 50C, and 50D. In the example of FIG. 2, the first thread is currently coding a tree block 52A, a second thread is currently coding a tree block 52B, a third thread is currently coding a tree block 52C, and a fourth thread is currently coding a tree block 52D. This disclosure may refer to tree blocks 52A, 52B, 52C, and 52D collectively as “tree blocks 52.” Tree blocks 52 may form a “tree block group.” Because the video coder may begin coding a tree block row after more than two tree blocks of an immediately higher row have been coded, tree blocks 52 are horizontally displaced from each other by the widths of two tree blocks.

In the example of FIG. 2, the threads may use data from tree blocks indicated by the thick gray arrows to perform intra prediction or inter prediction for CUs in tree blocks 52. (The threads may also use data from one or more reference frames to perform inter prediction for CUs.) To code a particular tree block, a thread may select one or more CABAC contexts based on information associated with previously-coded tree blocks. The thread may use the one or more CABAC contexts to perform CABAC coding on syntax elements associated with the first CU of the particular tree block. If the particular tree block is not the leftmost tree block of a row, the thread may select the one or more CABAC contexts based on information associated with a last CU of the tree block to the left of the particular tree block. If the particular tree block is the leftmost tree block of a row, the thread may select the one or more CABAC contexts based on information associated with a last CU of a tree block that is above and two tree blocks right of the particular tree block. The threads may use data from the last CUs of the tree blocks indicated by the thin black arrows to select CABAC contexts for the first CUs of tree blocks 52.

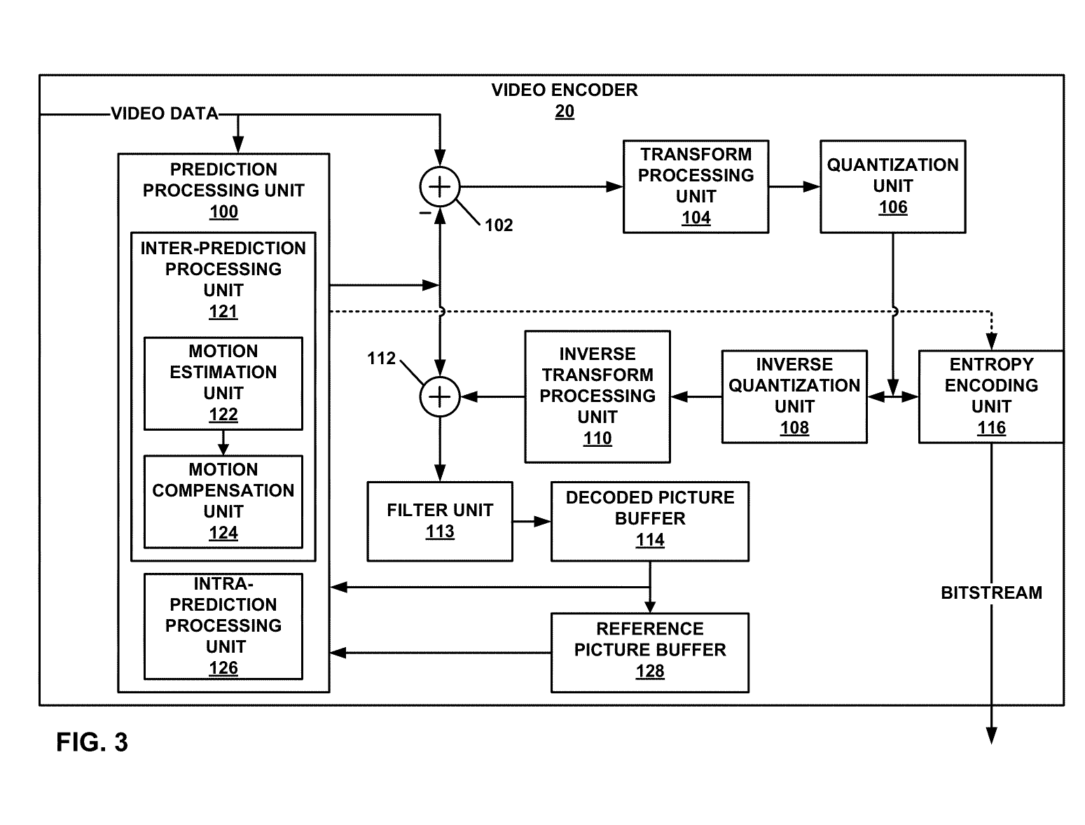

FIG. 3 is a block diagram that illustrates an example video encoder 20 that is configured to implement the techniques of this disclosure. FIG. 3 is provided for purposes of explanation and should not be considered limiting of the techniques as broadly exemplified and described in this disclosure. For purposes of explanation, this disclosure describes video encoder 20 in the context of HEVC coding. However, the techniques of this disclosure may be applicable to other coding standards or methods.

In the example of FIG. 3, video encoder 20 includes a plurality of functional components. The functional components of video encoder 20 include a prediction processing unit 100, a residual generation unit 102, a transform processing unit 104, a quantization unit 106, an inverse quantization unit 108, an inverse transform processing unit 110, a reconstruction unit 112, a filter unit 113, a decoded picture buffer 114, and an entropy encoding unit 116. Prediction processing unit 100 includes an inter-prediction processing unit 121 and an intra-prediction processing unit 126. Inter-prediction processing unit 121 includes a motion estimation unit 122 and a motion compensation unit 124. In addition, video encoder 20 includes a reference picture buffer 128. In other examples, video encoder 20 may include more, fewer, or different functional components.

Video encoder 20 may encode video data. To encode the video data, video encoder 20 may encode each tree block of each slice of each picture of the video data. As part of encoding a tree block, prediction processing unit 100 may perform quad-tree partitioning on the pixel block associated with the tree block to divide the pixel block into progressively smaller pixel blocks. The smaller pixel blocks may be associated with CUs. For example, prediction processing unit 100 may partition the pixel block of a tree block into four equally-sized sub-blocks, partition one or more of the sub-blocks into four equally-sized sub-sub-blocks, and so on.

The sizes of the pixel blocks associated with CUs may range from 8×8 pixels up to the size of the pixel blocks associated with the tree blocks with a maximum of 64×64 samples or greater. In this disclosure, “N×N” and “N by N” may be used interchangeably to refer to the pixel dimensions of a pixel block in terms of vertical and horizontal dimensions, e.g., 16×16 pixels or 16 by 16 pixels. In general, a 16×16 pixel block has sixteen pixels in a vertical direction (y=16) and sixteen pixels in a horizontal direction (x=16). Likewise, an N×N block generally has N pixels in a vertical direction and N pixels in a horizontal direction, where N represents a nonnegative integer value.

Video encoder 20 may encode CUs of a tree block to generate encoded representations of the CUs (i.e., coded CUs). Video encoder 20 may encode the CUs of a tree block according to a z-scan order. In other words, video encoder 20 may encode a top-left CU, a top-right CU, a bottom-left CU, and then a bottom-right CU, in that order. When video encoder 20 encodes a partitioned CU, video encoder 20 may encode CUs associated with sub-blocks of the pixel blocks of the partitioned CU according to the z-scan order. In other words, video encoder 20 may encode a CU associated with a top-left sub-block, a CU associated with a top-right sub-block, a CU associated with a bottom-left sub-block, and then a CU associated with a bottom-right sub-block, in that order.

As a result of encoding the CUs of a tree block according to a z-scan order, the CUs above, above-and-to-the-left, above-and-to-the-right, left, and below-and-to-the left of a particular CU may have been encoded. CUs below or to the right of the particular CU have not yet been encoded. Consequently, video encoder 20 may be able to access information generated by encoding some CUs that neighbor the particular CU when encoding the particular CU. However, video encoder 20 may be unable to access information generated by encoding other CUs that neighbor the particular CU when encoding the particular CU.

As part of encoding a CU, prediction processing unit 100 may partition the pixel blocks of the CU among one or more PUs of the CU. Video encoder 20 and video decoder 30 may support various PU sizes. Assuming that the size of a particular CU is 2N×2N, video encoder 20 and video decoder 30 may support PU sizes of 2N×2N or N×N for intra prediction, and symmetric PU sizes of 2N×2N, 2N×N, N×2N, N×N, or similar for inter prediction. Video encoder 20 and video decoder 30 may also support asymmetric partitioning for PU sizes of 2N×nU, 2N×nD, nL×2N, and nR×2N for inter prediction.

Inter-prediction processing unit 121 may perform inter prediction on each PU of the CU. Inter prediction may provide temporal compression. Inter-prediction processing unit 121 may generate predictive data for a PU. The predictive data for the PU may include predictive sample blocks that correspond to the PU and motion information for the PU. Motion estimation unit 122 may generate the motion information for the PU. In some instances, motion estimation unit 122 may use merge mode or advanced motion vector prediction (AMVP) mode to signal the motion information of the PU. Motion compensation unit 124 may generate the predictive sample blocks of the PU based on samples of one or more pictures other than the picture associated with the PU (i.e., reference pictures).

Slices may be I slices, P slices, or B slices. Motion estimation unit 122 and motion compensation unit 124 may perform different operations for a PU of a CU depending on whether the PU is in an I slice, a P slice, or a B slice. In an I slice, all PUs are intra predicted. Hence, if the PU is in an I slice, motion estimation unit 122 and motion compensation unit 124 do not perform inter prediction on the PU.

If the PU is in a P slice, the picture containing the PU is associated with a list of reference pictures referred to as “list 0.” Motion estimation unit 122 may search the reference pictures in list 0 for a reference block for a PU in a P slice. The reference block of the PU may be a pixel block that most closely corresponds to the pixel block of the PU. Motion estimation unit 122 may use a variety of metrics to determine how closely a pixel block in a reference picture corresponds to the pixel block of a PU. For example, motion estimation unit 122 may determine how closely a pixel block in a reference picture corresponds to the pixel block of a PU by sum of absolute difference (SAD), sum of square difference (SSD), or other difference metrics.

Motion estimation unit 122 may generate a reference picture index that indicates the reference picture in list 0 containing a reference block of a PU in a P slice and a motion vector that indicates a spatial displacement between the PU and the reference block. Motion estimation unit 122 may generate motion vectors to varying degrees of precision. For example, motion estimation unit 122 may generate motion vectors at one-quarter pixel precision, one-eighth pixel precision, or other fractional pixel precision. In the case of fractional pixel precision, samples in a reference block may be interpolated from integer-position samples in the reference picture. Motion estimation unit 122 may output the reference picture index and the motion vector as the motion information of the PU. Motion compensation unit 124 may generate the predictive sample blocks of the PU based on the reference block associated with the motion information of the PU.

If a PU is in a B slice, the picture containing the PU may be associated with two lists of reference pictures, referred to as “list 0” and “list 1.” Furthermore, if the PU is in a B slice, motion estimation unit 122 may perform uni-directional inter prediction or bi-directional inter prediction for the PU. To perform uni-directional inter prediction for the PU, motion estimation unit 122 may search the reference pictures of list 0 or list 1 for a reference block for the PU. Motion estimation unit 122 may generate a reference picture index that indicates a position in list 0 or list 1 of the reference picture that contains the reference block, a motion vector that indicates a spatial displacement between the PU and the reference block, and a prediction direction indicator that indicates whether the reference picture is in list 0 or list 1.

To perform bi-directional inter prediction for a PU, motion estimation unit 122 may search the reference pictures in list 0 for a reference block for the PU and may also search the reference pictures in list 1 for another reference block for the PU. Motion estimation unit 122 may generate reference picture indexes that indicate positions in list 0 and list 1 of the reference pictures that contain the reference blocks. In addition, motion estimation unit 122 may generate motion vectors that indicate spatial displacements between the reference blocks and the PU. The motion information of the PU may include the reference picture indexes and the motion vectors of the PU. Motion compensation unit 124 may generate the predictive sample blocks of the PU based on the reference blocks indicated by the motion information of the PU.

Furthermore, intra-prediction processing unit 126 may perform intra prediction on PUs of a CU. Intra prediction may provide spatial compression. Intra-prediction processing unit 126 may generate predictive data for a PU based on decoded samples in the same picture as the PU. The predictive data for the PU may include predictive sample blocks for the PU and various syntax elements. Intra-prediction processing unit 126 may perform intra prediction on PUs in I slices, P slices, and B slices.

To perform intra prediction on a PU, intra-prediction processing unit 126 may use multiple intra prediction modes to generate multiple sets of predictive data for the PU. To use an intra prediction mode to generate a set of predictive data for the PU, intra-prediction processing unit 126 may extend samples from sample blocks of neighboring PUs across the sample blocks of the PU in a direction and/or gradient associated with the intra prediction mode. The neighboring PUs may be above, above and to the right, above and to the left, or to the left of the PU, assuming a left-to-right, top-to-bottom encoding order for PUs, CUs, and tree blocks. Intra-prediction processing unit 126 may use various numbers of intra prediction modes, e.g., 33 directional intra prediction modes. In some examples, the number of intra prediction modes may depend on the size of the PU.

Prediction processing unit 100 may select the predictive data for PUs of a CU from among the predictive data generated by inter-prediction processing unit 121 for the PUs or the predictive data generated by intra-prediction processing unit 126 for the PUs. In some examples, prediction processing unit 100 selects the predictive data for the PUs of the CU based on rate/distortion metrics of the sets of predictive data.

Prediction processing unit 100 may perform quad-tree partitioning to partition the residual pixel block of a CU into sub-blocks. Each undivided residual pixel block may be associated with a different TU of the CU. The sizes and positions of the residual pixel blocks associated with TUs of a CU may or may not be based on the sizes and positions of pixel blocks of the PUs of the CU.

Because the pixels of the residual pixel blocks of the TUs comprise luma and chroma samples, each of the TUs may be associated with a sample block of luma samples and two blocks of chroma samples. Residual generation unit 102 may generate residual sample blocks for a CU by subtracting samples of predictive sample blocks of PUs of the CU from corresponding samples of the sample blocks of the CU.

Transform processing unit 104 may generate coefficient blocks for each TU of a CU by applying one or more transforms to the residual sample blocks associated with the TU. Transform processing unit 104 may apply various transforms to a residual sample block associated with a TU. For example, transform processing unit 104 may apply a discrete cosine transform (DCT), a directional transform, or a conceptually similar transform to the residual sample block associated with a TU.

Quantization unit 106 may quantize a coefficient block associated with a TU. The quantization process may reduce the bit depth associated with some or all of the coefficients. For example, an n-bit coefficient may be rounded down to an m-bit coefficient during quantization, where n is greater than m. Quantization unit 106 may quantize a coefficient block associated with a TU of a CU based at least in part on a quantization parameter (QP) value associated with the CU. Video encoder 20 may adjust the degree of quantization applied to the coefficient blocks associated with a CU by adjusting the QP value associated with the CU.

Inverse quantization unit 108 and inverse transform processing unit 110 may apply inverse quantization and inverse transforms to a coefficient block, respectively, to reconstruct a residual sample block from the coefficient block. Reconstruction unit 112 may add the reconstructed residual sample block to corresponding samples from one or more predictive sample blocks generated by prediction processing unit 100 to produce a reconstructed sample block associated with a TU. By reconstructing sample blocks for each TU of a CU in this way, video encoder 20 may reconstruct the sample blocks of the CU.

Filter unit 113 may perform a deblocking operation to reduce blocking artifacts in sample blocks associated with a CU. Decoded picture buffer 114 may store the reconstructed sample blocks after filter unit 113 performs the one or more deblocking operations on the reconstructed sample blocks. Motion estimation unit 122 and motion compensation unit 124 may use a reference picture that contains the reconstructed sample blocks to perform inter prediction on PUs of subsequent pictures. In addition, intra-prediction processing unit 126 may use reconstructed sample blocks in decoded picture buffer 114 to perform intra prediction on other PUs in the same picture as the CU.

When motion estimation unit 122 searches a reference picture for a reference block for a PU, motion estimation unit 122 may generate requests to read data representing pixel blocks of the reference picture. Motion estimation unit 122 may compare such pixel blocks to the pixel block associated with the PU. When motion estimation unit 122 generates a request to read data representing a pixel block of a reference picture, video encoder 20 may determine whether reference picture buffer 128 stores the reference picture. If reference picture buffer 128 does not store the reference picture, video encoder 20 may copy the reference picture from decoded picture buffer 114 to reference picture buffer 128 and provide the requested data to motion estimation unit 122.

Entropy encoding unit 116 may receive data from other functional components of video encoder 20. For example, entropy encoding unit 116 may receive coefficient blocks from quantization unit 106 and may receive syntax elements from prediction processing unit 100. Entropy encoding unit 116 may perform one or more entropy encoding operations on the data to generate entropy-encoded data. For example, video encoder 20 may perform a CABAC operation, a context-adaptive variable length coding (CAVLC) operation, a variable-to-variable (V2V) length coding operation, a syntax-based context-adaptive binary arithmetic coding (SBAC) operation, a Probability Interval Partitioning Entropy (PIPE) coding operation, or another type of entropy encoding operation on the data. Entropy encoding unit 116 may output a bitstream that includes the entropy-encoded data.

As part of performing an entropy encoding operation on the data, entropy encoding unit 116 may select a context model. If entropy encoding unit 116 is performing a CABAC operation, the context model may indicate estimates of probabilities of particular bins having particular values. In the context of CABAC, the term “bin” may be used to refer to a bit of a binarized version of a syntax element.

Video encoder 20 may use WPP to encode a slice of a picture. When video encoder 20 uses WPP to encode a slice of a picture, video encoder 20 may output, in a bitstream that includes a coded representation of the picture, a coded syntax element that indicates that the picture is to be decoded using WPP. In addition, video encoder 20 may indicate, in the bitstream, the reference picture set (RPS) of the picture. Video encoder 20 may indicate the RPS of the picture in various portions of the bitstream. For example, video encoder 20 may indicate the RPS of the picture in a PPS applicable to the picture. In another example, video encoder 20 may indicate the RPS of the picture in a SPS applicable to the picture.

Furthermore, when video encoder 20 uses WPP to encode a slice of a picture, video encoder 20 may encode a plurality of tree blocks of the slice in parallel. The set of tree blocks that video encoder 20 encodes in parallel may be referred to as a tree block group.

In accordance with the techniques of this disclosure, motion estimation unit 122 may determine a reference picture subset for a tree block group. Motion estimation unit 122 may determine the reference picture subset for the tree block group in various ways. For example, motion estimation unit 122 may determine that the reference picture subset for the tree block group includes only reference pictures having picture order count (POC) values that differ from a POC value of the current picture (i.e., the picture that video encoder 20 is currently encoding) by less than a given amount, such as plus or minus N. In one example, N may be equal to two.

Furthermore, in some examples, motion estimation unit 122 may determine the reference picture subset for the tree block group such that a size in bits of the reference pictures of the reference picture subset for the tree block group is below a threshold associated with a size of a reference picture buffer of a video decoder. For example, different video decoders may have different levels. Video decoders at different levels may have differently-sized reference picture buffers. In this example, if video encoder 20 is encoding video data for a particular level of video decoder, motion estimation unit 122 may determine the reference picture subset such that the size in bits of reference pictures in the reference picture subset is less than the size of reference picture buffers associated with video decoders of that level.

Motion estimation unit 122 may search, within the reference picture subset for the tree block group, for reference blocks for PUs of tree blocks of the tree block group. For example, the RPS of the picture may include reference pictures “A” through “F” and the reference picture subset for the tree block group may include only reference pictures “A” and “B.” In this example, motion estimation unit 122 does not search reference pictures “C” through “F” for reference blocks for the PUs of the tree blocks of the tree block group. Rather, motion estimation unit 122 only searches reference pictures “A” and “B” for reference blocks for the PUs of the tree blocks of the tree block group. Thus, motion estimation unit 122 may identify, for each respective PU of the tree blocks of the tree block group, one or more pixel blocks in reference pictures “A” or “B” that best match the pixel block of the respective PU.

Reference picture buffer 128 may concurrently store each of the reference pictures of the reference picture subset of the tree block group. For instance, in the example of the previous paragraph, reference picture buffer 128 may store reference pictures “A” and “B.” Because reference picture buffer 128 stores the reference pictures of the reference picture subset, motion estimation unit 122 may be able to search the reference pictures of the reference picture subset without retrieving the reference pictures of the reference picture subset from a secondary storage location, such as decoded picture buffer 114.

Because video encoder 20 may encode the tree blocks of the tree block group in parallel, motion estimation unit 122 may determine the reference blocks for two or more inter-predicted PUs of the tree block group concurrently. For example, the tree block group may include a first tree block and a second tree block. The first tree block may include a first PU and the second tree block may include a second PU. Motion estimation unit 122 may determine the reference blocks for the first and the second PU concurrently.

Motion estimation unit 122 may determine different reference picture subsets for different tree block groups of a picture. Thus, if the tree block group described in the preceding paragraphs is referred to as a first tree block group, motion estimation unit 122 may determine reference blocks for each inter-predicted PU of a second tree block group such that the reference blocks for each inter-predicted PU of the second tree block group are in reference pictures that are in a second reference picture subset. The second reference picture subset may be different than the first reference picture subset. The second reference picture subset may include less than all reference pictures in the reference picture set of the picture. The second tree block group may comprise a second plurality of concurrently-coded tree blocks in the picture. Furthermore, for each respective inter-predicted PU of the second tree block group, video encoder 20 may indicate, in the bitstream, a reference picture that includes the reference block for the respective inter-predicted PU of the second tree block group.

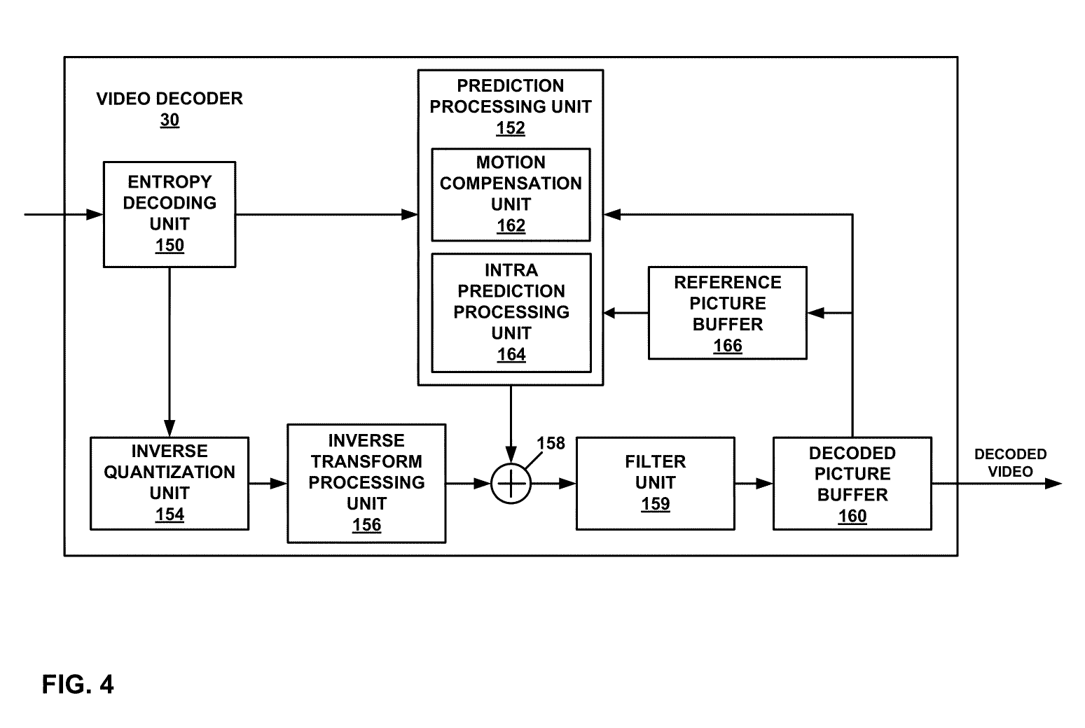

FIG. 4 is a block diagram that illustrates an example video decoder 30 that is configured to implement the techniques of this disclosure. FIG. 4 is provided for purposes of explanation and is not limiting on the techniques as broadly exemplified and described in this disclosure. For purposes of explanation, this disclosure describes video decoder 30 in the context of HEVC coding. However, the techniques of this disclosure may be applicable to other coding standards or methods.

In the example of FIG. 4, video decoder 30 includes a plurality of functional components. The functional components of video decoder 30 include an entropy decoding unit 150, a prediction processing unit 152, an inverse quantization unit 154, an inverse transform processing unit 156, a reconstruction unit 158, a filter unit 159, a decoded picture buffer 160, and a reference picture buffer 166. Prediction processing unit 152 includes a motion compensation unit 162 and an intra-prediction processing unit 164. In other examples, video decoder 30 may include more, fewer, or different functional components.

Video decoder 30 may receive a bitstream. Entropy decoding unit 150 may parse the bitstream to extract syntax elements from the bitstream. As part of parsing the bitstream, entropy decoding unit 150 may entropy decode (e.g., CABAC decode) entropy-encoded syntax elements in the bitstream. Prediction processing unit 152, inverse quantization unit 154, inverse transform processing unit 156, reconstruction unit 158, and filter unit 159 may generate decoded video data based on the syntax elements extracted from the bitstream.

The bitstream may comprise a series of NAL units. The NAL units of the bitstream may include SPS NAL units, PPS NAL units, SEI NAL units, coded slice NAL units, and so on.

Inverse quantization unit 154 may inverse quantize, i.e., de-quantize, coefficient blocks associated with TUs. Inverse quantization unit 154 may use a QP value associated with a CU of a TU to determine a degree of inverse quantization for inverse quantization unit 154 to apply to a coefficient block associated with the TU.

After inverse quantization unit 154 inverse quantizes a coefficient block associated with a TU, inverse transform processing unit 156 may apply one or more inverse transforms to the coefficient block in order to generate a residual sample block associated with the TU. For example, inverse transform processing unit 156 may apply an inverse DCT, an inverse integer transform, an inverse Karhunen-Loeve transform (KLT), an inverse rotational transform, an inverse directional transform, or another inverse transform to the coefficient block.

If an inter-predicted PU is encoded in skip mode or motion information of the PU is encoded using merge mode, motion compensation unit 162 may generate a merge candidate list for the PU. Motion compensation unit 162 may identify a selected merge candidate in the merge candidate list. Motion compensation unit 162 may generate predictive sample blocks for the PU based on the one or more reference blocks associated with the motion information indicated by the selected merge candidate.

In accordance with the techniques of this disclosure, motion compensation unit 162 may determine, based on the motion information of inter-predicted PUs of a tree block group, reference blocks of the inter-predicted PUs. Each of the reference blocks of the inter-predicted PUs of the tree block group is within a reference picture in a reference picture subset defined for the tree block group.

If motion information of an inter-predicted PU is encoded using AMVP mode, motion compensation unit 162 may generate a list 0 MV predictor candidate list and/or a list 1 MV predictor candidate list. Motion compensation unit 162 may determine a selected list 0 MV predictor candidate and/or a selected list 1 MV predictor candidate. Next, motion compensation unit 162 may determine a list 0 motion vector for the PU and/or a list 1 motion vector for the PU based on a list 0 motion vector difference (MVD), a list 1 MVD, a list 0 motion vector specified by the selected list 0 MV predictor candidate, and/or a list 1 motion vector specified by the selected list 1 MV predictor candidate. Motion compensation unit 162 may generate predictive sample blocks for the PU based on reference blocks associated with the list 0 motion vector and a list 0 reference picture index and/or a list 1 motion vector and a list 1 reference picture index.

In some examples, motion compensation unit 162 may refine the predictive sample blocks of a PU by performing interpolation based on interpolation filters. Identifiers for interpolation filters to be used for motion compensation with sub-pixel precision may be included in the syntax elements. Motion compensation unit 162 may use the same interpolation filters used by video encoder 20 during generation of the predictive sample blocks of the PU to calculate interpolated values for sub-integer samples of a reference block. Motion compensation unit 162 may determine the interpolation filters used by video encoder 20 according to received syntax information and may use the interpolation filters to produce the predictive sample blocks.

If a PU is encoded using intra prediction, intra-prediction processing unit 164 may perform intra prediction to generate predictive sample blocks for the PU. For example, intra-prediction processing unit 164 may determine an intra prediction mode for the PU based on syntax elements in the bitstream. Intra-prediction processing unit 164 may use the intra prediction mode to generate predictive sample blocks for the PU based on the sample blocks of PUs that spatially neighbor the PU.

Reconstruction unit 158 may use the residual sample blocks associated with TUs of a CU and the predictive sample blocks of the PUs of the CU to reconstruct the sample blocks of the CU. For instance, reconstruction unit 158 may add samples of the residual sample blocks to corresponding samples of the predictive sample blocks to reconstruct the sample blocks of the CU.

Filter unit 159 may perform a deblocking operation to reduce blocking artifacts associated with the CU. Decoded picture buffer 160 may store the sample blocks of the CU. Decoded picture buffer 160 may provide reference pictures for subsequent motion compensation, intra prediction, and presentation on a display device, such as display device 32 of FIG. 1. For instance, video decoder 30 may perform, based on the sample blocks in decoded picture buffer 160, intra prediction or inter prediction operations on PUs of other CUs.

When motion compensation unit 162 generates a predictive video block based on a reference block within a reference picture, motion compensation unit 162 may generate a request to read data representing the reference block. When motion compensation unit 162 generates a request to read data representing a reference block, video decoder 30 may determine whether reference picture buffer 166 stores a reference picture that contains the reference block. If reference picture buffer 166 does not store the reference picture, video encoder 20 may copy the reference picture from decoded picture buffer 160 to reference picture buffer 166 and provide the requested reference picture to motion compensation unit 162.

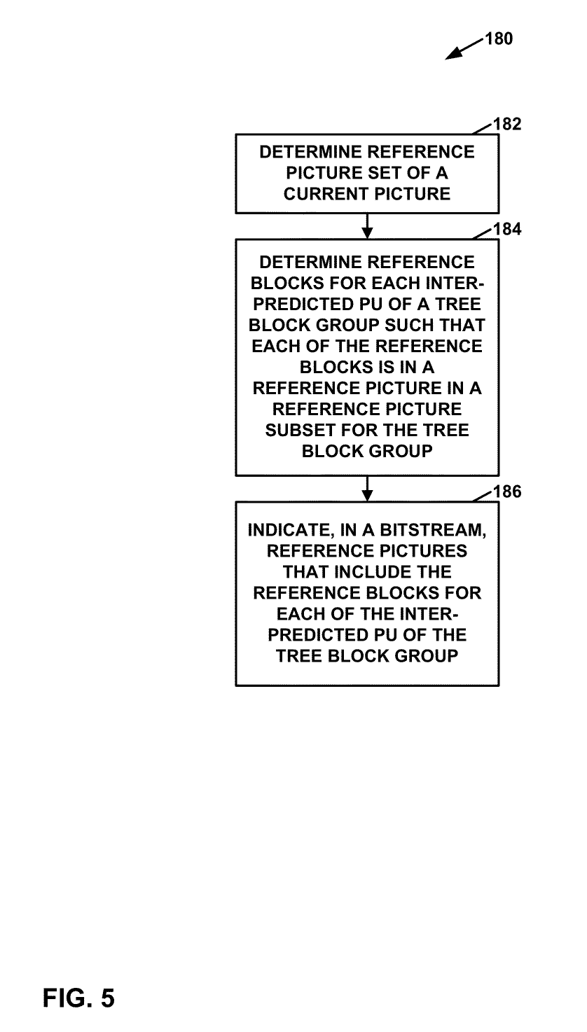

FIG. 5 is a flowchart that illustrates an example operation 180 of video encoder 20 to encode video data using constrained reference picture sets, in accordance with one or more techniques of this disclosure. In the example of FIG. 5, video encoder 20 may determine a reference picture set of a current picture (182). In addition, video encoder 20 may determine reference blocks for each inter-predicted PU of a tree block group such that each of the reference blocks is in a reference picture that is in a reference picture subset for the tree block group (184). The reference picture subset for the tree block group may include less than all reference pictures in the reference picture set of the current picture. The tree block group may comprise a plurality of concurrently-coded tree blocks in the current picture. Video encoder 20 may indicate, in a bitstream that includes a coded representation of the video data, reference pictures that include the reference blocks for each inter-predicted PU of the tree block group (186).

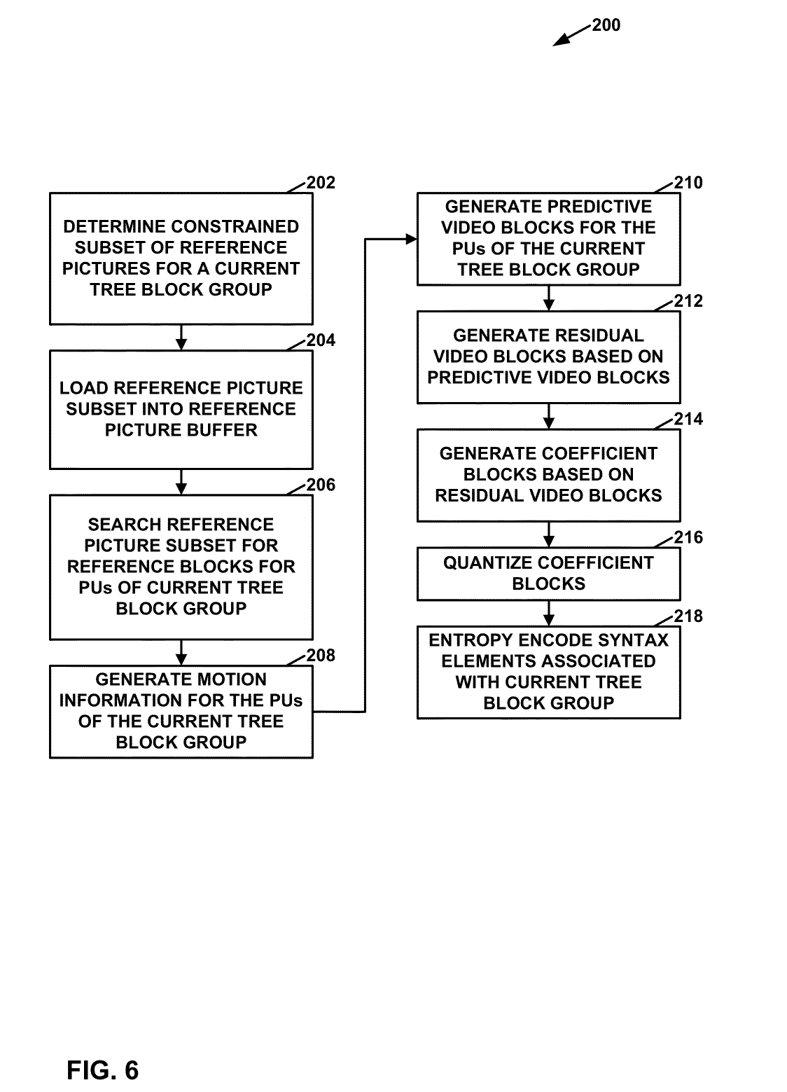

FIG. 6 is a flowchart that illustrates an example operation 200 of video encoder 20 to process a tree block group, in accordance with one or more techniques of this disclosure. Operation 200 may be a more specific example of operation 180 (FIG. 5). Video encoder 20 may perform operation 200 with respect to each tree block group in a picture.

As illustrated in the example of FIG. 6, video encoder 20 may determine a constrained subset of reference pictures for a current tree block group (202). In other words, video encoder 20 may determine a reference picture subset for the current tree block group. In addition, video encoder 20 may load the reference picture subset into the reference picture buffer (204). In some examples, video encoder 20 may load all of the reference pictures of the reference picture subset into the reference picture buffer at one time. In other examples, video encoder 20 may load the reference pictures of the reference picture subset into the reference picture buffer at the times the reference pictures are requested by video encoder 20.

Video decoder 20 may search the reference picture subset for reference blocks for PUs of the current tree block group (206). Furthermore, video decoder 20 may generate motion information (e.g., motion vectors, prediction direction indicators, reference picture indexes, etc.) for the PUs of the current tree block group (208). Video decoder 20 may also generate predictive video blocks for the PUs of the current tree block group (210).

Video decoder 20 may generate residual video blocks for CUs of the current tree block group based on the predictive video blocks of the PUs of the CUs and the original video blocks of the CUs (212). Video decoder 20 may apply one or more transforms to generate coefficient blocks based on the residual video blocks (214). In addition, video decoder 20 may quantize the coefficient blocks (216). Video decoder 20 may entropy encode the syntax elements associated with the current tree block group (218). The syntax elements associated with the current tree block group may include syntax elements that signal the quantized coefficient blocks of TUs of the CUs of the current tree block group, syntax elements that signal the motion information of inter-predicted PUs of the CUs of the current tree block group, and so on.

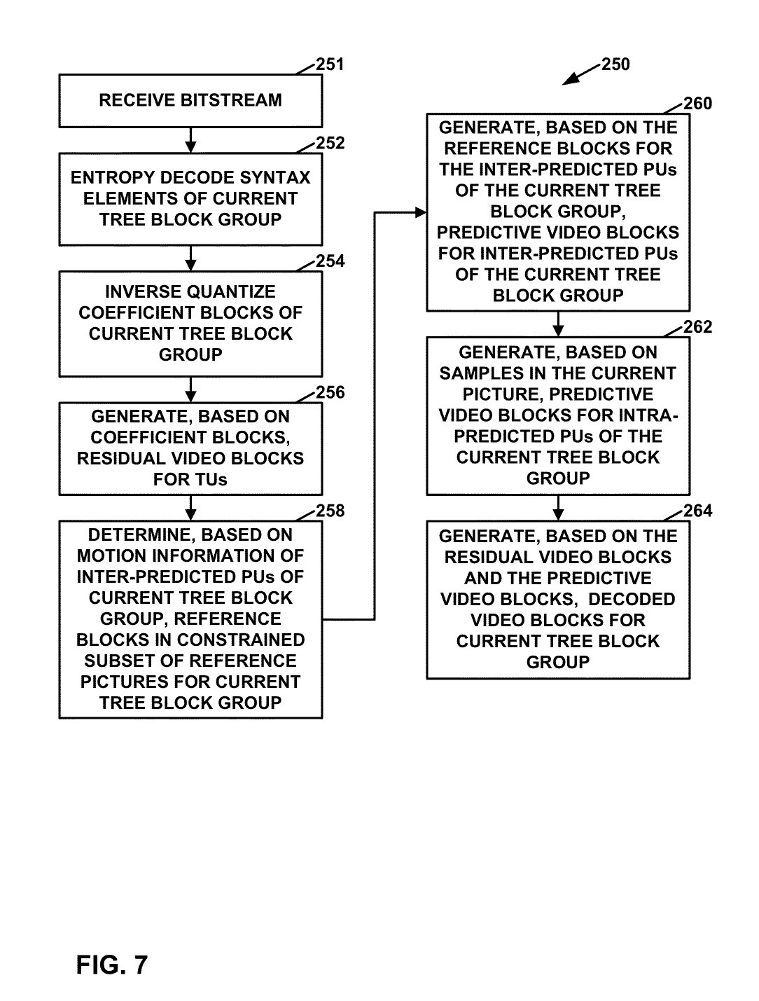

FIG. 7 is a flowchart that illustrates an example operation 250 of video decoder 30 to process a current tree block group, in accordance with one or more techniques of this disclosure. Video decoder 30 may perform operation 250 with respect to each tree block group of a picture.

As illustrated in the example of FIG. 7, video decoder 30 may receive a bitstream (251). In some examples, video decoder 30 may receive the bitstream from a channel 16. In other examples, video decoder 30 may receive the bitstream from a computer-readable storage medium, such as a disc or memory. The bitstream may include an encoded representation of video data. The encoded representation of the video data may include data that signal motion information of inter-predicted PUs of a current tree block group of a current picture of the video data.

Video decoder 30 may entropy decode syntax elements of the current tree block group (252). For example, video decoder 30 may perform CABAC decoding on at least some of the syntax elements of the current tree block group. The syntax elements of the current tree block group may include syntax elements that signal quantized coefficient blocks of TUs of CUs of the current tree block group, syntax elements that indicate motion information of inter-predicted PUs of the CUs of the current tree block group, and so on.

Furthermore, video decoder 30 may inverse quantize the coefficient blocks of the TUs of the CUs of the current tree block group (254). Video decoder 30 may generate, based on the coefficient blocks, residual video blocks for the TUs of the CUs of the current tree block group (256). For instance, video decoder 30 may apply an inverse discrete cosine transform to each coefficient block to generate the residual video blocks.

In addition to inverse quantizing the coefficient blocks and generating the residual video blocks, video decoder 30 may determine, based on the motion information of inter-predicted PUs of the current tree block group, reference blocks in a constrained subset of reference pictures (i.e., a reference picture subset) for the current tree block group (258). In addition, video decoder 30 may generate, based on the reference blocks for the inter-predicted PUs of the current tree block group, predictive video blocks for the inter-predicted PUs of the current tree block group (260). Video decoder 30 may generate, based on samples in the current picture, predictive video blocks for intra-predicted PUs of the current tree block group (262). Video decoder 30 may generate, based on the residual video blocks of the TUs of the CUs of the current tree block group and the predictive video blocks of the PUs of the CUs of the current tree block group, decoded video blocks for the CUs of the current tree block group (264). In this way, video decoder 30 may generate, based at least in part on the reference blocks of the inter-predicted PUs of the current tree block group, decoded video blocks of the current picture.

Video decoder 30 may perform the example operation of FIG. 7 for each tree block group of a picture. Thus, the current tree block group may be a first tree block group of the current picture, the reference picture subset may be a first reference picture subset and the bitstream may include data that signal motion information of inter-predicted PUs of a second tree block group of the current picture. The second tree block group may comprise a second plurality of concurrently-coded tree blocks in the current picture. Video decoder 30 may determine, based on the motion information reference of the inter-predicted PUs of the second tree block group, reference blocks of the inter-predicted PUs of the second tree block group. Each of the reference blocks of the inter-predicted PUs of the inter-predicted PUs of the second tree block group may be in reference pictures that are in a second reference picture subset. The second reference picture subset is different than the first reference picture subset. The second reference picture subset includes one or more, but less than all, of the reference pictures in the reference picture set of the current picture. Furthermore, video decoder 30 may generate, based at least in part on the reference blocks of the inter-predicted PUs of the second tree block group, additional decoded video blocks of the current picture.

FIG. 8 is a conceptual diagram that illustrates an example approach for constraining the reference picture set of a picture, in accordance with one or more techniques of this disclosure. In the example of FIG. 8, a tree block 300 is partitioned into CUs that are partitioned into PUs 302. It is assumed, in the example of FIG. 8, that each of PUs 302 is an inter-predicted PU.

In the example of FIG. 8, video encoder 20 has constrained the reference picture set such that the reference blocks for each of PUs 302 are in the same reference picture, refl. Furthermore, tree block 300 may be part of a tree block group. In the example of FIG. 8, the reference picture subset for the tree block group may include only a single one of the reference pictures in the reference picture set of a picture associated with tree block 300. In the example of FIG. 8, video encoder 20 does not necessarily partition the tree blocks of the tree block group into PUs in the same way.

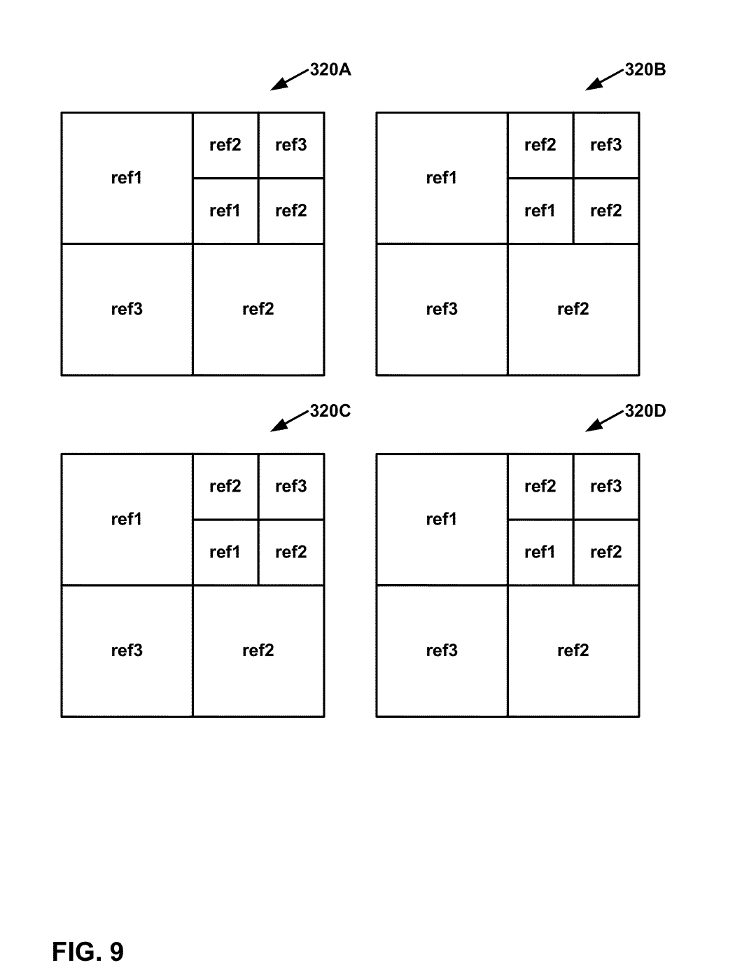

FIG. 9 is a conceptual diagram that illustrates another example approach for constraining the reference picture set of a picture, in accordance with one or more techniques of this disclosure. In the example of FIG. 9, tree blocks 320A, 320B, 320C, and 320D (collectively, “tree blocks 320”) belong to the same tree block group. In other words, a video coder may code tree blocks 320 concurrently when coding a picture using WPP. It is assumed, in the example of FIG. 9, that each of the PUs is an inter-predicted PU. In accordance with the example approach of FIG. 9, video encoder 20 partitions tree blocks 320 into CUs and PUs in the same way. That is, for each respective PU of tree blocks 320, the size and position of the respective PU matches the size and position of PUs in each other one of tree blocks 320.

In the example of FIG. 9, video encoder 20 has constrained the reference picture set of the picture such that the reference blocks for corresponding PUs are in the same reference picture. For instance, video encoder 20 may constrain the reference picture set such that the top-left PUs of each of tree blocks 320 are inter-predicted using the same reference picture, ref1. Similarly, video encoder 20 may constrain the reference picture set such that the lower-left PUs of each of tree blocks 320 are inter-predicted using the same reference picture, ref3, and so on.

Thus, in the example of FIG. 9, video encoder 20 may partition the pixel blocks of each tree block of a tree block group such that, for each respective inter-predicted PU of a particular tree block of the tree block group, there is, in each other tree block of the tree block group, an inter-predicted PU that corresponds to the respective inter-predicted PU of the particular tree block. The inter-predicted PU that corresponds to the respective inter-predicted PU of the particular tree block has a reference block in a same reference picture as a reference block of the respective inter-predicted PU of the particular tree block. The inter-predicted PU that corresponds to the respective inter-predicted PU of the particular tree block is associated with a pixel block has a size and a position that corresponds to a size and a position of a pixel block associated with the respective inter-predicted PU of the particular tree block. Furthermore, the inter-predicted PU that corresponds to the respective inter-predicted PU of the particular tree block has a reference block in a same reference picture as a reference block of the respective inter-predicted PU of the particular tree block.

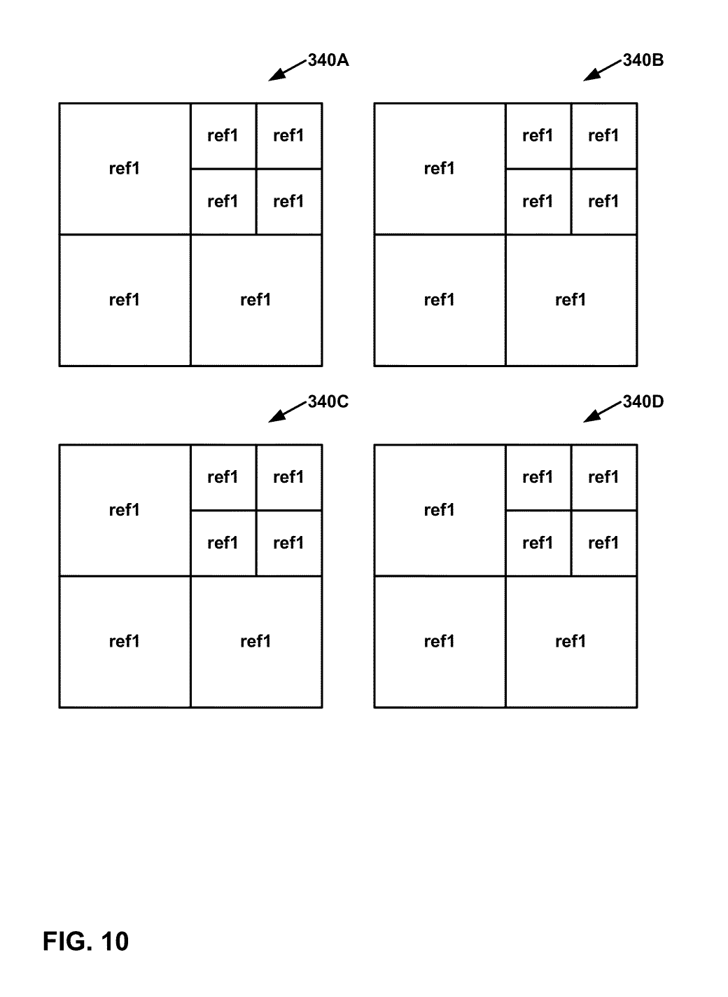

FIG. 10 is a conceptual diagram that illustrates another example approach for constraining the reference picture set of a picture, in accordance with one or more techniques of this disclosure. In the example of FIG. 10, tree blocks 340A, 340B, 340C, and 340D (collectively, “tree blocks 340”) belong to the same tree block group. In accordance with the example approach of FIG. 10, video encoder 20 partitions tree blocks 340 into CUs and PUs in the same way. That is, for each respective PU of tree blocks 340, the size and position of the respective PU matches the size and position of PUs in each other one of tree blocks 340. It is assumed, in the example of FIG. 10, that each of the PUs is an inter-predicted PU. Furthermore, in the example of FIG. 10, video encoder 20 has constrained the reference picture set of the current picture such that the reference blocks for each of the PUs is inter-predicted using the same reference picture, ref1.

Thus, in the example of FIG. 10, video encoder 20 may partition the pixel blocks of each tree block of a tree block group such that, for each respective inter-predicted PU of a particular tree block of the tree block group, there is, in each other tree block of the tree block group, an inter-predicted PU that corresponds to the respective inter-predicted PU of the particular tree block. The reference picture subset for the tree block group includes only a single one of the reference pictures in the reference picture set of the current picture. The inter-predicted PU that corresponds to the respective inter-predicted PU of the particular tree block has a reference block in a same reference picture as a reference block of the respective inter-predicted PU of the particular tree block. The inter-predicted PU that corresponds to the respective inter-predicted PU of the particular tree block is associated with a pixel block has a size and a position that corresponds to a size and a position of a pixel block associated with the respective inter-predicted PU of the particular tree block. Furthermore, the inter-predicted PU that corresponds to the respective inter-predicted PU of the particular tree block has a reference block in a same reference picture as a reference block of the respective inter-predicted PU of the particular tree block.

In other examples, video encoder 20 may partition the pixel blocks of each tree block of a tree block group in the same way. However, in such examples, video encoder 20 may use different reference pictures to perform inter prediction on the PUs.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method for encoding video data, the method comprising:
determining a reference picture set comprising a plurality of reference pictures for a current picture;
determining reference blocks for each inter-predicted prediction unit (PU) of a tree block group of the current picture such that each of the reference blocks is in a reference picture that is in a reference picture subset for the tree block group, the reference picture subset for the tree block group including one or more, but less than all, of the reference pictures in the reference picture set for the current picture, the tree block group comprising a plurality of concurrently-coded tree blocks in the current picture; and
indicating, in a bitstream that includes a coded representation of the video data, reference pictures that include the reference blocks for each inter-predicted PU of the tree block group.

2. The method of claim 1, wherein the reference picture subset includes only a single one of the reference pictures in the reference picture set of the current picture.

3. The method of claim 1, further comprising determining the reference picture subset for the tree block group based on a temporal range restriction.

4. The method of claim 1, wherein the method further comprises partitioning pixel blocks of each of the tree blocks of the tree block group such that, for each respective inter-predicted PU of a particular tree block of the tree block group, there is, in each other tree block of the tree block group, an inter-predicted PU that corresponds to the respective inter-predicted PU of the particular tree block, and
wherein the inter-predicted PU that corresponds to the respective inter-predicted PU of the particular tree block is associated with a pixel block has a size and a position that corresponds to a size and a position of a pixel block associated with the respective inter-predicted PU of the particular tree block.

5. The method of claim 4, wherein the reference picture subset includes only a single one of the reference pictures in the reference picture set of the current picture.

6. The method of claim 4, wherein the inter-predicted PU that corresponds to the respective inter-predicted PU of the particular tree block has a reference block in a same reference picture as a reference block of the respective inter-predicted PU of the particular tree block.

7. The method of claim 1, further comprising outputting, in the bitstream, a coded syntax element that indicates that the current picture is to be decoded using wavefront parallel processing (WPP).

8. The method of claim 1, further comprising concurrently storing in a reference picture buffer each of the reference pictures of the reference picture subset, but not each of the reference pictures of the reference picture set of the current picture.

9. The method of claim 1, further comprising determining the reference picture subset for the tree block group such that a size in bits of the reference pictures of the reference picture subset for the tree block group is below a threshold associated with a size of a reference picture buffer of a video decoder.

10. The method of claim 1, wherein determining the reference blocks for each inter-predicted PU of the tree block group comprises determining the reference blocks for two or more inter-predicted PUs of the tree block group concurrently.

11. The method of claim 1, wherein each of the tree blocks of the tree block group is in a different row of tree blocks of the current picture and each of the tree blocks of the tree block group is vertically offset from each other by two tree block columns of the current picture.

12. The method of claim 1, wherein the tree block group is a first tree block group of the current picture, the reference picture subset is a first reference picture subset, and the method further comprises:
determining reference blocks for each inter-predicted PU of a second tree block group such that the reference blocks for each inter-predicted PU of the second tree block group are in reference pictures that are in a second reference picture subset, the second reference picture subset being different than the first reference picture subset, the second reference picture subset including one or more, but less than all, of the reference pictures in the reference picture set of the current picture, the second tree block group comprising a second plurality of concurrently-coded tree blocks in the current picture; and
for each respective inter-predicted PU of the second tree block group, indicating, in the bitstream, a reference picture that includes the reference block for the respective inter-predicted PU of the second tree block group.

13. A computing device that comprises one or more processors configured to:
determine a reference picture set comprising a plurality of reference pictures for a current picture;
determine reference blocks for each inter-predicted prediction unit (PU) of a tree block group of the current picture such that each of the reference blocks is in a reference picture that is in a reference picture subset for the tree block group, the reference picture subset for the tree block group including one or more, but less than all, of the reference pictures in the reference picture set for the current picture, the tree block group comprising a plurality of concurrently-coded tree blocks in the current picture; and
indicate, in a bitstream that includes a coded representation of the video data, reference pictures that include the reference blocks for each inter-predicted PU of the tree block group.

14. The computing device of claim 13, wherein the reference picture subset includes only a single one of the reference pictures in the reference picture set of the current picture.

15. The computing device of claim 13, wherein the one or more processors are configured to determine the reference picture subset for the tree block group based on a temporal range restriction.

16. The computing device of claim 13, wherein the one or more processors are further configured to partition pixel blocks of each of the tree blocks of the tree block group such that, for each respective inter-predicted PU of a particular tree block of the tree block group, there is, in each other tree block of the tree block group, an inter-predicted PU that corresponds to the respective inter-predicted PU of the particular tree block, and
wherein the inter-predicted PU that corresponds to the respective inter-predicted PU of the particular tree block is associated with a pixel block has a size and a position that corresponds to a size and a position of a pixel block associated with the respective inter-predicted PU of the particular tree block.

17. The computing device of claim 16, wherein the reference picture subset includes only a single one of the reference pictures in the reference picture set of the current picture.

18. The computing device of claim 16, wherein the inter-predicted PU that corresponds to the respective inter-predicted PU of the particular tree block has a reference block in a same reference picture as a reference block of the respective inter-predicted PU of the particular tree block.

19. The computing device of claim 13, wherein the one or more processors are configured to output, in the bitstream, a syntax element that indicates that the current picture is to be decoded using wavefront parallel processing (WPP).

20. The computing device of claim 13, further comprising a reference picture buffer that concurrently stores each of the reference pictures of the reference picture subset, but not each of the reference pictures of the reference picture set of the current picture.

21. The computing device of claim 13, wherein the one or more processors are configured to determine the reference picture subset for the tree block group such that a size in bits of the reference pictures of the reference picture subset for the tree block group is below a threshold associated with a size of a reference picture buffer of a video decoder.

22. The computing device of claim 13, wherein the one or more processors are configured to determine reference blocks for two or more inter-predicted PUs of the tree block group concurrently.

23. The computing device of claim 13, wherein each of the tree blocks of the tree block group is in a different row of tree blocks of the current picture and each of the tree blocks of the tree block group is vertically offset from each other by two tree block columns of the current picture.

24. The computing device of claim 13, wherein the tree block group is a first tree block group of the current picture, the reference picture subset is a first reference picture subset, and the one or more processors are further configured to:
determine reference blocks for each inter-predicted PU of a second tree block group such that the reference blocks for each inter-predicted PU of the second tree block group are in reference pictures that are in a second reference picture subset, the second reference picture subset being different than the first reference picture subset, the second reference picture subset including less than all reference pictures in the reference picture set of the current picture, the second tree block group comprising a second plurality of concurrently-coded tree blocks in the current picture; and
for each respective inter-predicted PU of the second tree block group, indicate, in the bitstream, a reference picture that includes the reference block for the respective inter-predicted PU of the second tree block group.

25. A computing device that comprises:
means for determining a reference picture set comprising a plurality of reference pictures for a current picture;
means for determining reference blocks for each inter-predicted prediction unit (PU) of a tree block group of the current picture such that each of the reference blocks is in a reference picture that is in a reference picture subset for the tree block group, the reference picture subset for the tree block group including one or more, but less than all, of the reference pictures in the reference picture set for the current picture, the tree block group comprising a plurality of concurrently-coded tree blocks in the current picture; and
means for indicating, in a bitstream that includes a coded representation of video data, reference pictures that include the reference blocks for each inter-predicted PU of the tree block group.

26. A computer-readable storage medium that stores instructions that, when executed by one or more processors of a computing device, cause the computing device to:
determine a reference picture set comprising a plurality of reference pictures for a current picture;
determine reference blocks for each inter-predicted prediction unit (PU) of a tree block group of the current picture such that each of the reference blocks is in a reference picture that is in a reference picture subset for the tree block group, the reference picture subset for the tree block group including one or more, but less than all, of the reference pictures in the reference picture set of the current picture, the tree block group comprising a plurality of concurrently-coded tree blocks in the current picture; and
indicate, in a bitstream that includes a coded representation of video data, reference pictures that include the reference blocks for each inter-predicted PU of the tree block group.

27. A method for decoding video data, the method comprising:
receiving a bitstream that includes an encoded representation of the video data, the encoded representation of the video data including data that signal motion information of inter-predicted prediction units (PUs) of a tree block group of a current picture of the video data, the tree block group comprising a plurality of concurrently-coded tree blocks in the current picture, wherein the tree block group is associated with a reference picture subset that includes one or more, but less than all, reference pictures in a reference picture set for the current picture;
determining, based on the motion information of the inter-predicted PUs of the tree block group, reference blocks of the inter-predicted PUs, wherein each of the reference blocks of the inter-predicted PUs of the tree block group is within a reference picture in a reference picture subset defined for the tree block group; and
generating, based at least in part on the reference blocks of the inter-predicted PUs of the tree block group, decoded video blocks of the current picture.

28. The method of claim 27, wherein the reference picture subset includes only a single one of the reference pictures in the reference picture set of the current picture.

29. The method of claim 27, wherein the reference picture subset associated with the tree block group is based on a temporal range restriction.

30. The method of claim 27, wherein pixel blocks of each of the tree blocks of the tree block group are partitioned such that, for each respective inter-predicted PU of a particular tree block of the tree block group, there is, in each other tree block of the tree block group, an inter-predicted PU that corresponds to the respective inter-predicted PU of the particular tree block, and
wherein the inter-predicted PU that corresponds to the respective inter-predicted PU of the particular tree block is associated with a pixel block has a size and a position that corresponds to a size and a position of a pixel block associated with the respective inter-predicted PU of the particular tree block.

31. The method of claim 30, wherein the reference picture subset includes only a single one of the reference pictures in the reference picture set of the current picture.

32. The method of claim 30, wherein the inter-predicted PU that corresponds to the respective inter-predicted PU of the particular tree block has a reference block in a same reference picture as a reference block of the respective inter-predicted PU of the particular tree block.

33. The method of claim 27, wherein generating the decoded video blocks of the current picture comprises decoding the current picture using wavefront parallel processing (WPP).

34. The method of claim 27, further comprising concurrently storing in a reference picture buffer each of the reference pictures of the reference picture subset, but not each of the reference pictures of the reference picture set of the current picture.

35. The method of claim 27, wherein a size in bits of the reference pictures of the reference picture subset for the tree block group is below a threshold associated with a size of a reference picture buffer.

36. The method of claim 27, wherein determining the reference blocks of the inter-predicted PU of the tree block group comprises determining the reference blocks for two or more inter-predicted PUs of the tree block group concurrently.

37. The method of claim 27, wherein each of the tree blocks of the tree block group is in a different row of tree blocks of the current picture and each of the tree blocks of the tree block group is vertically offset from each other by two tree block columns of the current picture.

38. The method of claim 27, wherein the tree block group is a first tree block group of the current picture, the reference picture subset is a first reference picture subset, the bitstream includes data that signal motion information of inter-predicted PUs of a second tree block group of the current picture, the second tree block group comprising a second plurality of concurrently-coded tree blocks in the current picture, and the method further comprises:
determining, based on the motion information reference of the inter-predicted PUs of the second tree block group, reference blocks of the inter-predicted PUs of the second tree block group, wherein each of the reference blocks of the inter-predicted PUs of the inter-predicted PUs of the second tree block group are in reference pictures that are in a second reference picture subset, the second reference picture subset being different than the first reference picture subset, the second reference picture subset including one or more, but less than all, of the reference pictures in the reference picture set of the current picture; and
generating, based at least in part on the reference blocks of the inter-predicted PUs of the second tree block group, additional decoded video blocks of the current picture.

39. A computing device that comprises one or more processors configured to:
receive a bitstream that includes an encoded representation of video data, the encoded representation of the video data including data that signal motion information of inter-predicted prediction units (PUs) of a tree block group of a current picture of the video data, the tree block group comprising a plurality of concurrently-coded tree blocks in the current picture, wherein the tree block group is associated with a reference picture subset that includes one or more, but less than all, reference pictures in a reference picture set for the current picture;
determine, based on the motion information of the inter-predicted PUs of the tree block group, reference blocks of the inter-predicted PUs, wherein each of the reference blocks of the inter-predicted PUs of the tree block group is within a reference picture in a reference picture subset defined for the tree block group; and
generate, based at least in part on the reference blocks of the inter-predicted PUs of the tree block group, decoded video blocks of the current picture.

40. The computing device of claim 39, wherein the reference picture subset includes only a single one of the reference pictures in the reference picture set of the current picture.

41. The computing device of claim 39, wherein the reference picture subset associated with the tree block group is based on a temporal range restriction.

42. The computing device of claim 39, wherein pixel blocks of each of the tree blocks of the tree block group are partitioned such that, for each respective inter-predicted PU of a particular tree block of the tree block group, there is, in each other tree block of the tree block group, an inter-predicted PU that corresponds to the respective inter-predicted PU of the particular tree block, and
wherein the inter-predicted PU that corresponds to the respective inter-predicted PU of the particular tree block is associated with a pixel block has a size and a position that corresponds to a size and a position of a pixel block associated with the respective inter-predicted PU of the particular tree block.

43. The computing device of claim 42, wherein the reference picture subset includes only a single one of the reference pictures in the reference picture set of the current picture.

44. The computing device of claim 42, wherein the inter-predicted PU that corresponds to the respective inter-predicted PU of the particular tree block has a reference block in a same reference picture as a reference block of the respective inter-predicted PU of the particular tree block.

45. The computing device of claim 39, wherein one or more processors decode the current picture using wavefront parallel processing (WPP).

46. The computing device of claim 39, wherein the one or more processors are configured to concurrently store in a reference picture buffer each of the reference pictures of the reference picture subset, but not each of the reference pictures of the reference picture set of the current picture.

47. The computing device of claim 39, wherein a size in bits of the reference pictures of the reference picture subset for the tree block group is below a threshold associated with a size of a reference picture buffer.

48. The computing device of claim 39, wherein determining the reference blocks of the inter-predicted PU of the tree block group comprises determining the reference blocks for two or more inter-predicted PUs of the tree block group concurrently.

49. The computing device of claim 39, wherein each of the tree blocks of the tree block group is in a different row of tree blocks of the current picture and each of the tree blocks of the tree block group is vertically offset from each other by two tree block columns of the current picture.

50. The computing device of claim 39, wherein the tree block group is a first tree block group of the current picture, the reference picture subset is a first reference picture subset, the bitstream includes data that signal motion information of inter-predicted PUs of a second tree block group of the current picture, the second tree block group comprising a second plurality of concurrently-coded tree blocks in the current picture, and the one or more processors are configured to:
determine, based on the motion information reference of the inter-predicted PUs of the second tree block group, reference blocks of the inter-predicted PUs of the second tree block group, wherein each of the reference blocks of the inter-predicted PUs of the inter-predicted PUs of the second tree block group are in reference pictures that are in a second reference picture subset, the second reference picture subset being different than the first reference picture subset, the second reference picture subset including one or more, but less than all, of the reference pictures in the reference picture set of the current picture; and
generate, based at least in part on the reference blocks of the inter-predicted PUs of the second tree block group, additional decoded video blocks of the current picture.

51. A computing device that comprises:
means for receiving a bitstream that includes an encoded representation of video data, the encoded representation of the video data including data that signal motion information of inter-predicted prediction units (PUs) of a tree block group of a current picture of the video data, the tree block group comprising a plurality of concurrently-coded tree blocks in the current picture, wherein the tree block group is associated with a reference picture subset that includes one or more, but less than all, reference pictures in a reference picture set for the current picture;
means for determining, based on the motion information of the inter-predicted PUs of the tree block group, reference blocks of the inter-predicted PUs, wherein each of the reference blocks of the inter-predicted PUs of the tree block group is within a reference picture in a reference picture subset defined for the tree block group; and
means for generating, based at least in part on the reference blocks of the inter-predicted PUs of the tree block group, decoded video blocks of the current picture.

52. A computer-readable storage medium that stores instructions that, when executed by one or more processors of a computing device, cause the computing device to:
receive a bitstream that includes an encoded representation of video data, the encoded representation of the video data including data that signal motion information of inter-predicted prediction units (PUs) of a tree block group of a current picture of the video data, the tree block group comprising a plurality of concurrently-coded tree blocks in the current picture, wherein the tree block group is associated with a reference picture subset that includes one or more, but less than all, reference pictures in a reference picture set for the current picture;
determine, based on the motion information of the inter-predicted PUs of the tree block group, reference blocks of the inter-predicted PUs, wherein each of the reference blocks of the inter-predicted PUs of the tree block group is within a reference picture in a reference picture subset defined for the tree block group; and
generate, based at least in part on the reference blocks of the inter-predicted PUs of the tree block group, decoded video blocks of the current picture.
